(19) United States
(12) Patent Application Publication
(10) Pub. No.: US 2013/0242233 A1
(43) Pub. Date: Sep. 19, 2013

(54) LIQUID CRYSTAL LAYER AND DISPLAY DEVICE

(71) Applicant: SEMICONDUCTOR ENERGY LABORATORY CO., LTD., (US)

(72) Inventors: Daisuke KUBOTA, Isehara (JP); Makoto IKENAGA, Atsugi (JP)

(73) Assignee: SEMICONDUCTOR ENERGY LABORATORY CO., LTD., Atsugi-shi (JP)

(21) Appl. No.: 13/787,989

(22) Filed: Mar. 7, 2013

(30) Foreign Application Priority Data
Mar. 13, 2012 (JP) 2012-055786
Mar. 13, 2012 (JP) 2012-055799

(51) Int. Cl. G02F 1/1337

(52) U.S. Cl. CPC G02F 1/133753
USPC 349/73

(57) ABSTRACT

The occurrence of defective orientation of a composite of a polymer and a liquid crystal is suppressed. Furthermore, the occurrence of defective display of a liquid crystal display device including the composite of a polymer and a liquid crystal is suppressed. The composite of a polymer and a liquid includes a plurality of domains with different periods of alignment, a boundary formed between the plurality of domains, and a region where the plurality of domains adjoin and bond to one another without the boundary. The composite of a polymer and a liquid crystal exhibits a blue phase.

### BACKGROUND OF THE INVENTION

1. Field of the Invention

The present invention relates to a composite of a polymer and a liquid crystal, and particularly to a composite of a polymer and a liquid crystal which contains a liquid crystal material exhibiting a blue phase. The present invention also relates to a liquid crystal display device and an electronic device each of which contains the composite of a polymer and a liquid crystal.

2. Description of the Related Art

As a display device which is thin and lightweight (a flat panel display), a liquid crystal display device including a liquid crystal element, a light-emitting device including a self light-emitting element, a field emission display (an FED), and the like have been competitively developed.

Low response speed is often cited as a disadvantage of a liquid crystal display device. One method for improving the response speed of a liquid crystal display device is selection of display modes capable of displaying at a high speed such as an in-plane switching (IPS) mode and an optical compensated bend (OCB) mode. To improve the response speed, there is not only the method in the aspect of a display mode but also a method in the aspect of a liquid crystal material capable of high-speed response. The liquid crystal material capable of high-speed response is a ferroelectric liquid crystal (FLC), a liquid crystal material which exhibits a liquid crystal phase showing the Kerr effect, or the like. Examples of a liquid crystal phase showing the Kerr effect include a cholesteric blue phase, a smectic blue phase, and a quasi-isotropic phase.

A cholesteric blue phase (also simply referred to as a blue phase) is a liquid crystal phase which is exhibited between a chiral nematic phase having a relatively short spiral pitch and an isotropic phase, and has a feature of an extremely high-speed response. A blue phase is optically isotropic; thus, a liquid crystal display device formed with a liquid crystal exhibiting a blue phase has features in that orientation treatment is not necessary and a viewing angle is wide. However, the blue phase is exhibited only in a small temperature range of 1° C. to 3° C. Thus, there is a problem in that the temperature of the element needs to be controlled precisely.

As a method for solving this problem, it is proposed that the temperature range where a liquid crystal material contained in a liquid crystal composition exhibits a blue phase be widened by subjecting the liquid crystal composition to polymer stabilization treatment (see Patent Document 1, for example). Specifically, Patent Document 1 discloses a technique to stabilize a blue phase of a liquid crystal material (or to expand the temperature range where a blue phase is exhibited) with a polymer (a polymer network) formed by photopolymerization or thermal polymerization of monomers contained in the liquid crystal composition.

### REFERENCE

[Patent Document 1] PCT International Publication No. 2005/090520

### SUMMARY OF THE INVENTION

However, a composite of a polymer and a liquid crystal that can be obtained by the above-mentioned polymer stabilization treatment does not exhibit a blue phase (i.e., a liquid crystal material which can exhibit a blue phase exhibits a phase other than a blue phase, hereinafter such a case is also referred to as defective orientation) in some cases. This directly leads to defective display of a liquid crystal display device including the composite of a polymer and a liquid crystal.

It is known that a composite of a polymer and a liquid crystal, which exhibits a blue phase and has been subjected to the polymer stabilization treatment, shows a platelet texture as illustrated in FIG. 11, for example. FIG. 11 is a photograph of a composite of a polymer and a liquid crystal, which exhibits a blue phase and has been subjected to the polymer stabilization treatment. The photograph was taken with a confocal laser microscope. In the case where a composite of a polymer and a liquid crystal, which exhibits a blue phase and has such a texture, is used as a display element of a liquid crystal display device, light leakage occurs at boundaries of the platelet textures; consequently, high-contrast images are less likely obtained.

In view of the above problem, an object of one embodiment of the present invention is to suppress the occurrence of defective orientation of a composite of a polymer and a liquid crystal. Another object is to suppress the occurrence of defective display of a liquid crystal display device including the composite of a polymer and a liquid crystal.

Another object of one embodiment of the present invention is to provide a composite of a polymer and a liquid crystal that enables a liquid crystal display device utilizing a blue phase to display high-contrast images with the use of the composite of a polymer and a liquid crystal as a display element. Another object of one embodiment of the present invention is to provide a liquid crystal display device and an electronic device each utilizing a blue phase and displaying high-contrast images.

One embodiment of the present invention is a composite of a polymer and a liquid crystal, which exhibits a blue phase. The composite of a polymer and a liquid crystal includes a plurality of domains with different periods of alignment (also referred to as an alignment state), a boundary formed between the plurality of domains, and a region where the plurality of domains adjoin and bond to one another without a boundary. Note that in this specification and the like, a “period of alignment” refers to a period of molecular arrangement that form a blue phase.

The composite of a polymer and a liquid crystal, which exhibits a blue phase, includes a plurality of domains. Adjacent domains have different periods of alignment; in other words, as to two adjacent domains, at least one of a polar angle and an azimuth of one domain is different from that of the other domain. In the case where the composite of a polymer and a liquid crystal is composed of a plurality of domains with high periodicity of alignment, a phase other than a blue phase, such as a cholesteric phase, might be locally exhibited at a boundary between adjacent domains or in some of the domains, whereby defective orientation might occur. This is probably because the periodicity of alignment of each of domains is too high and thus the domains are separated or continuity of the domains is decreased at each boundary between the domains. Therefore, by lowering the periodicity of alignment at a boundary between the domains, the occurrence of defective orientation due to a boundary between adjacent domains or some of the domains can be suppressed. Details will be described below.

One embodiment of the present invention is a composite of a polymer and a liquid crystal, and in an image thereof which is taken with a confocal laser microscope and magnified by 100 times, a stripe pattern owing to alignment of the composite of a polymer and a liquid crystal is observed. At least two regions in each of which stripe patterns in different alignments are adjacent to one another without a boundary exist in an area of 15 μm×15 μm in the imaged composite of a polymer and a liquid crystal.

Another embodiment of the present invention is a composite of a polymer and a liquid crystal which exhibits a blue phase and includes a plurality of domains. Adjacent domains among the plurality of domains have different periods of alignment, which means that at least polar angles of the adjacent domains or azimuths of the adjacent domains are different. A boundary between the adjacent domains includes a first contact at which the periods of alignment of the adjacent domains are different and a second contact at which the periods of alignment of the adjacent domains are bonded.

In a composite of a polymer and a liquid crystal according to one embodiment of the present invention, the occurrence of defective orientation can be suppressed. Furthermore, in the composite of a polymer and a liquid crystal, the occurrence of light leakage can be suppressed. Accordingly, it is possible to reduce defective display of a liquid crystal display device and an electronic device each including the composite of a polymer and a liquid crystal.

### BRIEF DESCRIPTION OF THE DRAWINGS

FIG. 1 schematically illustrates a texture of a composite of a polymer and a liquid crystal.

FIG. 2 illustrates a liquid crystal element.

FIG. 3 illustrates a liquid crystal element.

FIGS. 4A and 4B illustrate a liquid crystal display device.

FIGS. 5A and 5B illustrate a liquid crystal display device.

FIGS. 6A to 6D each illustrate an electronic device.

FIGS. 7A to 7C illustrate an electronic device.

FIG. 8 shows imaging data of a composite of a polymer and a liquid crystal of Example taken with a confocal laser microscope.

FIG. 9 shows imaging data of the composite of a polymer and a liquid crystal of Example taken with a confocal laser microscope.

FIG. 10 shows imaging data of the composite of a polymer and a liquid crystal of Example taken with a confocal laser microscope.

FIG. 11 shows imaging data of a composite of a polymer and a liquid crystal of a comparative example taken with a confocal laser microscope.

FIG. 12 shows imaging data of the composite of a polymer and a liquid crystal of the comparative example taken with a confocal laser microscope.

FIG. 13A is a graph showing reflectance spectra of composites of a polymer and a liquid crystal of one embodiment of the present invention and FIG. 13B is a graph showing reflectance spectra of composites of a polymer and a liquid crystal of the comparative example.

### DETAILED DESCRIPTION OF THE INVENTION

Embodiments of the present invention will be described below in detail. Note that the present invention is not limited to the description below, and a variety of changes can be made without departing from the spirit and scope of the present invention. Therefore, the invention should not be construed as being limited to the description below.

The position, size, range, or the like of each structure illustrated in drawings and the like is not accurately represented in some cases for easy understanding. Therefore, the disclosed invention is not necessarily limited to the position, size, range, or the like disclosed in the drawings and the like.

In this specification and the like, ordinals such as “first”, “second”, and “third” are used in order to avoid confusion among components and do not limit the number of components.

A liquid crystal display device in this specification means an image display device or a display device. A liquid crystal display device includes all the following modules in its category: a module to which a connector, for example, an FPC (flexible printed circuit), a TAB (tape automated bonding) tape, or a TCP (tape carrier package) is attached; a module in which a printed wiring board is provided at an end of a TAB tape or a TCP; and a module in which an IC (integrated circuit) is directly mounted on a display element by a COG (chip on glass) method.

In this specification, an element substrate which corresponds to one mode before the display element is completed in a manufacturing process of the liquid crystal display device, and the element substrate is provided with means for supplying current to the display element in each of a plurality of pixels. Specifically, the element substrate may be in a state where only a pixel electrode of the display element is provided, a state after formation of a conductive film to be a pixel electrode and before etching of the conductive film to form the pixel electrode, or any other states.

### Embodiment 1

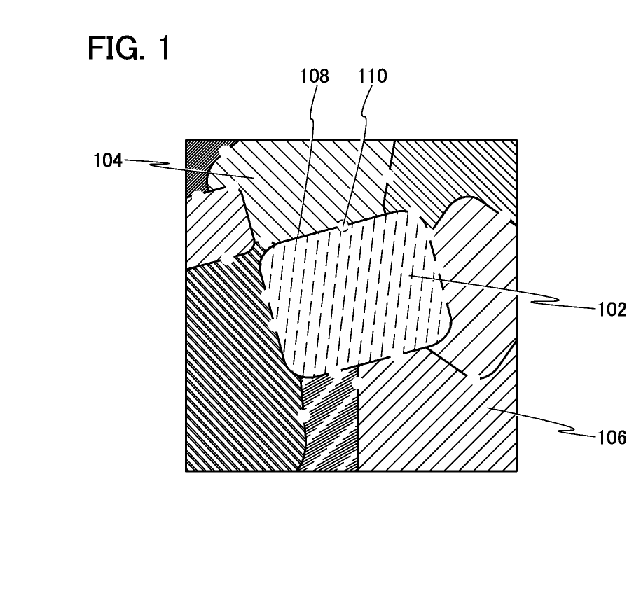

In this embodiment, a composite of a polymer and a liquid crystal, which exhibits a blue phase and is one embodiment of the present invention, will be described with reference to FIG. 1.

FIG. 1 schematically illustrates an example of a texture of the composite of a polymer and a liquid crystal, which exhibits a blue phase and is one embodiment of the present invention. The texture is observed with a microscope (e.g., a confocal laser microscope).

The texture illustrated in FIG. 1 includes a plurality of domains (a first domain 102, a second domain 104, and an n-th domain 106 (n is a natural number)). Adjacent domains among the plurality of domains have different periods of alignment. That is, at least polar angles of the adjacent domains or azimuths of the adjacent domains are different. A boundary between the adjacent domains includes a first contact 108 at which the periods of alignment of the adjacent domains are different and a second contact 110 at which the periods of alignment of the adjacent domains are bonded.

That is, the texture illustrated in FIG. 1 illustrates a structure of a composite of a polymer and a liquid crystal, which exhibits a blue phase. The composite of a polymer and a liquid crystal includes a plurality of domains with different periods of alignment, a boundary formed between the plurality of domains, and a region where the plurality of domains adjoin and bond to one another without the boundary. With the use of the composite of a polymer and a liquid crystal with such a characteristic texture illustrated in FIG. 1, the occurrence of defective orientation and the occurrence of light leakage can be suppressed.

For example, in the case of a structure of a plurality of domains which includes only the first contact 108 at which periods of alignment of the adjacent domains are different (also referred to as a multi-domain structure), a phase other than a blue phase, such as a cholesteric phase, can be locally generated at a boundary between adjacent domains or some of the domains. This is because each of domains has a high periodicity of alignment and thus the domains are separated or continuity of the domains is decreased at each boundary between the domains.

On the other hand, the texture illustrated in FIG. 1 of this embodiment includes the first contact 108 at which periods of alignment of the adjacent domains are different and the second contact 110 at which periods of alignment of the adjacent domains are bonded. Owing to the second contact 110, the occurrence of a boundary between adjacent domains can be suppressed or the continuity of the domains can be improved; thus, the occurrence of defective orientation can be suppressed.

Thus, a structure of the plurality of domains including the second contacts 110 at which periods of alignment of the adjacent domains are bonded can be regarded as a one-domain structure (also referred to as a mono-domain structure).

The proportion of the second contacts 110 to the first contacts 108 is preferably high in which the periodicity of alignment of the plurality of domains is lowered.

Although FIG. 1 schematically illustrates the first domain 102, the second domain 104, and the n-th domain 106, the shapes of the domains are not limited thereto. For example, the shape of the domain in a planar view may be a polygon, a circle, or an ellipse.

The technical idea of the present invention is that, in an observed texture of a composite of a polymer and a liquid crystal, which exhibits a blue phase, periodicity of alignment is lowered and domains are partly bonded to one another and thus a contact at which periods of alignment of the adjacent domains are bonded; the contact at which periods of alignment of the adjacent domains are bonded can suppress the occurrence of defective orientation due to a boundary between adjacent domains or some of the domains.

With the composite of a polymer and a liquid crystal, which exhibits a blue phase and has the texture illustrated in FIG. 1, the occurrence of defective orientation can be suppressed.

Note that the composite of a polymer and a liquid crystal described in this embodiment can be formed by subjecting a liquid crystal composition including a liquid crystal material exhibiting a blue phase to polymer stabilization treatment. The liquid crystal composition, the polymer stabilization treatment, and the composite of a polymer and a liquid crystal will be described below in detail.

### <Liquid Crystal Composition>

The composite of a polymer and a liquid crystal can be formed by subjecting a liquid crystal composition including a liquid crystal material exhibiting a blue phase to polymer stabilization treatment. For example, as the liquid crystal composition, a liquid crystal composition which includes a liquid crystal material exhibiting a blue phase, a liquid-crystalline monomer, a non-liquid-crystalline monomer, and a polymerization initiator can be used.

A blue phase is a phase in which light is not substantially scattered and which is optically isotropic. As the liquid crystal material exhibiting a blue phase, there are a nematic liquid-crystalline compound, a smectic liquid-crystalline compound, and the like, and the nematic liquid-crystalline compound is preferred. Note that the nematic liquid-crystalline compound is not particularly limited, and examples thereof are a biphenyl-based compound, a terphenyl-based compound, a phenylcyclohexyl-based compound, a biphenylcyclohexyl-based compound, a phenylbicyclohexyl-based compound, a benzoic acid phenyl-based compound, a cyclohexyl benzoic acid phenyl-based compound, a phenyl benzoic acid phenyl-based compound, a bicyclohexyl carboxylic acid phenyl-based compound, an azomethine-based compound, azo- and azoxy-based compounds, a stilbene-based compound, a bicyclohexyl-based compound, a phenylpyrimidine-based compound, a biphenylpyrimidine-based compound, a pyrimidine-based compound, a biphenyl ethyne-based compound, and the like.

The liquid-crystalline monomer is a monomer that has a liquid crystallinity and can be polymerized through photopolymerization. For example, as the liquid-crystalline monomer, a monomer having a mesogenic skeleton and two alkyl chains can be used. Note that the mesogenic skeleton in this specification refers to a highly rigid unit having two or more rings such as aromatic rings. The two alkyl chains may be the same or different.

The non-liquid-crystalline monomer refers to a monomer that does not have a liquid crystallinity, can be polymerized through photopolymerization, and does not have a rod-shaped molecular structure (for example, a molecular structure with an alkyl group, a cyano group, a fluorine, or the like present at an end of a biphenyl group, a biphenyl-cyclohexyl group, or the like). Specifically, there are monomers containing polymerizable groups such as acryloyl groups, methacryloyl groups, vinyl groups, epoxy groups, fumarate groups, cinnamoyl groups, and the like in molecular structures; however, the non-liquid-crystalline monomer is not limited to these examples.

The photopolymerization reaction disclosed in this specification may be caused using any kind of light; it is preferable to use ultraviolet light. Therefore, as the polymerization initiator, an acetophenone-based compound, a benzophenone-based compound, a benzoin-based compound, a benzil-based compound, a Michler's ketone-based compound, a benzoin alkylether-based compound, a benzil dimethylketal-based compound, or a thioxanthone-based compound can be used as appropriate, for example. Note that after the polymer stabilization treatment, the polymerization initiator becomes an impurity that does not contribute to operation of a liquid crystal display device in the composite of the polymer and the liquid crystal; therefore, the amount of the polymerization initiator is preferably as small as possible. For example, the amount of the polymerization initiator is preferably less than or equal to 0.5 wt % in the liquid crystal composition.

The liquid crystal composition may include a chiral material, in addition to the liquid crystal material exhibiting a blue phase, the liquid-crystalline monomer, the non-liquid-crystalline monomer, and the polymerization initiator. Note that the chiral material is a material with which a twist structure is caused in a liquid crystal material. The amount of the chiral material added affects the diffraction wavelength of the liquid crystal material exhibiting a blue phase. Therefore, the amount of the chiral material to be added is preferably adjusted so that the diffraction wavelength of the liquid crystal material exhibiting a blue phase is out of a visible region (380 nm to 750 nm). As the chiral material, S-811 (produced by Merck), S-1011 (produced by Merck), 1,4:3,6-dianhydro-2,5-bis [4-(n-hexyl-1-oxy)benzoic acid] sorbitol (abbreviation: ISO-(60BA)₂) (produced by Midori Kagaku Co., Ltd.), or the like can be selected as appropriate.

Note that a chiral agent having strong twisting power is preferably used for the liquid crystal composition because a composite of a polymer and a liquid crystal can be obtained which causes less light leakage and shows the following characteristic texture: in imaging data obtained with a confocal laser microscope, a stripe pattern owing to alignment of the composite of a polymer and a liquid crystal is observed, and two or more regions where stripe patterns in different alignments are adjacent to one another without a boundary exist per area of 15 μm×15 μm.

### <Polymer Stabilization Treatment>

By subjecting the above-described liquid crystal composition to polymer stabilization treatment (polymerization treatment), a composite of a polymer and a liquid crystal containing the liquid crystal material whose blue phase is stabilized with a polymer can be obtained. Note that the polymer stabilization treatment is a treatment for stabilizing the blue phase of the liquid crystal material with a polymer (a polymer network) which is formed by polymerization of the liquid-crystalline monomer and the non-liquid-crystalline monomer contained in the liquid crystal composition.

For example, as the polymer stabilization treatment, a treatment in which the liquid crystal composition is irradiated with ultraviolet light in a temperature range where the liquid crystal material exhibiting a blue phase exhibits a blue phase or an isotropic phase can be employed. Note that the liquid crystal composition according to one embodiment of the present invention allows the polymer stabilization treatment to be achieved not only in a temperature range where the liquid crystal material exhibiting a blue phase exhibits a blue phase but also in a temperature range where it exhibits an isotropic phase.

This makes it possible to obtain a composite of a polymer and a liquid crystal which includes a polymer (a polymer network) obtained by photopolymerization of the liquid-crystalline monomer and the non-liquid-crystalline monomer contained in the liquid crystal composition, and a liquid crystal material whose blue phase is stabilized with the polymer (the polymer network).

Note that as the liquid crystalline monomer and/or the non-liquid-crystalline monomer contained in the liquid crystal composition, it is preferable to select a monomer which decreases phase transition temperature of a liquid crystal material at which a blue phase is exhibited by being contained in the liquid crystal material. The liquid crystal composition including such a monomer allows the polymer stabilization treatment to be achieved not only in a temperature range where the liquid crystal material exhibiting a blue phase exhibits the blue phase but also in a temperature range where it exhibits an isotropic phase. In the case where a liquid crystal material is applied to a display, when polymer stabilization treatment is performed at a temperature at which a liquid crystal material exhibits a blue phase, defective orientation is likely to occur near a display region; however, the occurrence of such defective orientation near the display region can be suppressed by polymer stabilization treatment performed at a temperature at which a liquid crystal material exhibits an isotropic phase.

Monomers such as the liquid-crystalline monomer and the non-liquid-crystalline monomer contained in the liquid crystal composition are likely to affect the temperature of phase transition between blue and isotropic phases in the liquid crystal material exhibiting a blue phase which is contained in the liquid crystal composition. Specifically, as the proportion of the monomer contained in the liquid crystal composition increases, the phase transition temperature is lowered (or raised). On the other hand, polymers (the polymer network) obtained by polymerization of monomers are unlikely to affect the phase transition temperature. Therefore, as the proportion of the monomers decreases (or the proportion of the polymer increases) through the polymer stabilization treatment (polymerization treatment), the phase transition temperature is also raised (or lowered) linearly.

In this regard, in the case of employing the above method to obtain a composite of a polymer and a liquid crystal, it is preferable to select monomers capable of lowering the phase transition temperature of the liquid crystal material exhibiting a blue phase, as the liquid-crystalline monomer and the non-liquid-crystalline monomer contained in the liquid crystal composition. This can easily cause the phase transition from an isotropic phase to a blue phase in the liquid crystal composition.

For the liquid crystal composition described in this embodiment, a liquid crystalline monomer represented by the general formula (G1) is preferably used as a liquid crystalline monomer, in which case the composite of a polymer and a liquid crystal which shows a characteristic texture and causes less light leakage can be obtained. In addition, polymer-stabilized blue phase can be obtained by the polymer stabilization treatment performed not only in a temperature range where the liquid crystal composition exhibits a blue phase but also in a temperature range where the liquid crystal composition exhibits an isotropic phase, which contributes to suppression of the occurrence of defective orientation generated near a display region of a display.

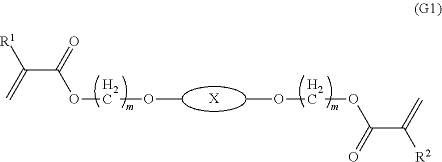

In the general formula (G1), X represents a mesogenic group, and R₁ and R₂ each independently represents hydrogen or a methyl group. The chain length (the sum of carbon atoms and oxygen atoms) of an oxyalkylene group ((—O—(CH₂)ₘ—), m is an integer) is an odd number greater than or equal to 3 and less than or equal to 11.

A composite of a polymer and a liquid crystal, which is obtained by subjecting a liquid crystal composition including the liquid crystalline monomer represented by the general formula (G1) to polymer stabilization treatment, shows a characteristic texture and causes less light leakage. With the use of this composite of a polymer and a liquid crystal as a display element, a display with high contrast can be provided.

The liquid crystalline monomer subjected to polymer stabilization treatment can form, for example, a structure represented by the general formula (G2) in the polymer.

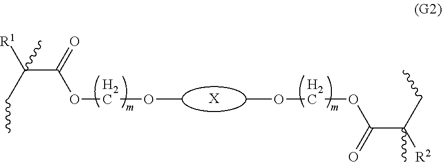

Note that the liquid crystalline monomer contained in a liquid crystal material for forming the composite of a polymer and a liquid crystal described in this embodiment is not limited to the liquid crystalline monomer represented by the general formula (G1).

For example, a material represented by the structural formula (100) can be used as the liquid crystalline monomer.

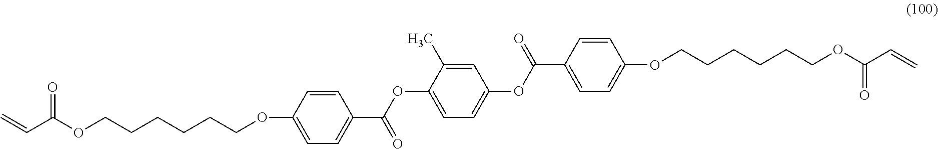 [SMILES: C=CC(=O)OCCCCCCOc1ccc(C(=O)Oc2ccc(OC(=O)c3ccc(OCCCCCCOC(=O)C=C)cc3)c(C)c2)cc1]

The material represented by the structural formula (100) is 1,4-bis-[4-(6-acryloyloxy-n-hexyl-1-oxy)benzoyloxy]-2-methylbenzene (abbreviation: RM257-O6), which is a liquid crystalline monomer in which the chain length (the sum of carbon atoms and oxygen atoms) of an oxyalkylene group is 7.

The use of a liquid crystalline monomer in which the chain length of an oxyalkylene group is an odd number (e.g., the chain length is 5, 7, 9, or 11) can more suitably lower periodicity of alignment of a plurality of domains of the composite of a polymer and a liquid crystal which has been subjected to polymer stabilization treatment.

### <Composite of Polymer and Liquid Crystal>

By the above-described polymer stabilization treatment, the composite of a polymer and a liquid crystal according to one embodiment of the present invention can be obtained. In an image of the composite of a polymer and a liquid crystal which is taken with a confocal laser microscope and magnified by 100 times or more, a region where stripe patterns owing to alignment of the composite of a polymer and a liquid crystal are adjacent to one another without a boundary is observed. Such regions are observed at least two portions in an area of 15 μm×15 μm in the imaged composite of a polymer and a liquid crystal. In the composite of a polymer and a liquid crystal showing such an observation image, a boundary between different alignments is relatively not clear, which means that an amount of light leaks from the boundary can be reduced.

The imaging data also shows that a texture in a region near a glass substrate (a surface region) differs from a texture in a bulk region (an inner region). Specifically, in the inner region, a portion (which corresponds to a defect such as a boundary between alignments) observed as a dark portion in the surface region disappears or additionally appears. In the composite of a polymer and a liquid crystal which shows such textures, a portion where a boundary between alignments is not continuous exists in the thickness direction of a liquid crystal layer; thus, light leakage can be reduced further effectively.

A plurality of units (one unit also referred to as one domain) of the composite of a polymer and a liquid crystal which have different alignments and different stripe patterns are observed. A bonding part exists between one domain and at least one adjacent domain. This can be regarded as a phenomenon that different domains partly bond to each other. In the composite of a polymer and a liquid crystal showing such an observation image, a boundary is unclear, which means that light leakage can be further reduced.

When incident light has a wavelength of 300 nm to 800 nm, the half width of a reflectance spectrum of the composite of a polymer and a liquid crystal according to one embodiment of the present invention is greater than or equal to 30 nm and less than or equal to 60 nm. As to a composite of a polymer and a liquid crystal in which periodicity of alignments is lowered at a boundary between a plurality of domains, the half width of a reflectance spectrum is within the above range.

Specifically, in the case of a composite of a polymer and a liquid crystal with high periodicity of alignments, a reflectance spectrum of the composite of a polymer and a liquid crystal has a sharp peak, with the half width of less than 30 nm. In contrast, the composite of a polymer and a liquid crystal according to one embodiment of the present invention has a texture where periods of alignments are bonded, that is, a texture where the periodicity of alignment is lowered, so that the composite of a polymer and a liquid crystal can have a broad reflectance spectrum with a half width greater than or equal to 30 nm and less than or equal to 60 nm.

As described above, the composite of a polymer and a liquid crystal, which exhibits a blue phase and is one embodiment of the present invention, has a structure such that periodicity of alignment of a plurality of domains existing in the composite of a polymer and a liquid crystal is lowered. The use of such a composite of a polymer and a liquid crystal can reduce the occurrence of defective orientation.

Furthermore, the composite of a polymer and a liquid crystal according to one embodiment of the present invention has a favorable characteristic of less light leakage. A liquid crystal display device manufactured with the use of the composite of a polymer and a liquid crystal which causes less light leakage can keep the characteristics of a liquid crystal layer exhibiting a blue phase (e.g., response speed is high and an alignment film is not needed) and display high-contrast images.

Note that an optical system of a confocal laser microscope is characterized by the capability of eliminating information of the non-focal plane and extracting only information of the focal plane. In addition, it enables an observation in the thickness direction as well as in the planar direction. Accordingly, a difference between periods of alignment of a texture can be observed with the optical system, as long as at least the polar angle or the azimuth is different.

This embodiment can be implemented in combination with any of the other embodiments the example as appropriate.

### Embodiment 2

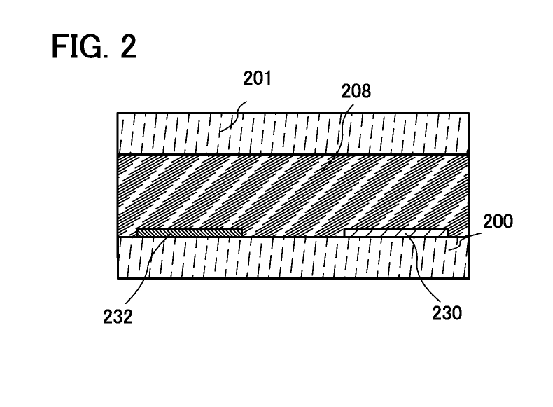

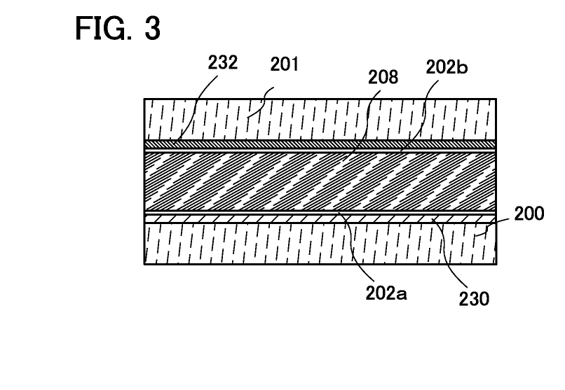

An example of the liquid crystal element according to one embodiment of the present invention will be described with reference to FIG. 2 and FIG. 3. In FIG. 2, a substrate on a side viewed by a viewer is a second substrate 201.

Note that in this specification and the like, a liquid crystal element is an element which controls transmission or non-transmission of light by an optical modulation action of liquid crystal. In this embodiment, the liquid crystal element includes the composite of a polymer and a liquid crystal showing the characteristic texture described in Embodiment 1.

FIG. 2 and FIG. 3 each illustrate a liquid crystal display device in which a first substrate 200 and the second substrate 201 are provided to face each other with a liquid crystal layer 208 including a composite of a polymer and a liquid crystal showing the characteristic texture described in Embodiment 1 interposed therebetween. The positions of the pixel electrode layer 230 and the common electrode layer 232 with respect to the liquid crystal layer 208 are different between the liquid crystal element of FIG. 2 and the liquid crystal element of FIG. 3.

In FIG. 2, a liquid crystal is controlled by an electric field formed between the pixel electrode layer 230 and the common electrode layer 232. An electric field in the direction parallel to the substrate is formed for the liquid crystal, so that liquid crystal molecules can be controlled using the electric field. The liquid crystal composition exhibiting a blue phase is capable of quick response. Thus, a high-performance liquid crystal element can be provided. That is, the liquid crystal molecules aligned to exhibit a blue phase can be controlled in the direction parallel to the substrate, whereby a wide viewing angle can be obtained.

Such a liquid crystal composition exhibiting a blue phase is capable of quick response, and this can be favorably used for a successive additive color mixing method (a field sequential method) or a three-dimensional display method. In the successive additive color mixing method, light-emitting diodes (LEDs) of RGB or the like are arranged in a backlight unit and color display is performed by time division, and in the three-dimensional display method, a shutter glasses system is used in which images for a right eye and images for a left eye are alternately viewed by time division.

In the liquid crystal element illustrated in FIG. 3, the pixel electrode layer 230 and the common electrode layer 232 are provided on the first substrate 200 side and the second substrate 201 side, respectively, with the liquid crystal layer 208 including a composite of a polymer and a liquid crystal interposed therebetween. With the structure in FIG. 3, a method in which the gray scale is controlled by generating an electric field substantially perpendicular to a substrate to move liquid crystal molecules in a plane perpendicular to the substrate can be used. An alignment film 202a may be provided between the liquid crystal layer 208 and the pixel electrode layer 230 and an alignment film 202b may be provided between the liquid crystal layer 208 and the common electrode layer 232.

The pixel electrode layer 230 and the common electrode layer 232 have a distance at which liquid crystal in the composite of a polymer and a liquid crystal included in the liquid crystal layer 208 can respond to a predetermined voltage which is applied to the pixel electrode layer 230 and the common electrode layer 232. The voltage applied is controlled depending on the distance as appropriate.

The maximum thickness (film thickness) of the liquid crystal layer 208 is preferably greater than or equal to 1 μm and less than or equal to 20 μm.

Next, an example of a liquid crystal display device, which is one embodiment of the present invention, is described. The liquid crystal display device can be manufactured by arranging a plurality of liquid crystal elements described above in a matrix. The liquid crystal display device, which is one embodiment of the present invention, may be a transmissive liquid crystal display device or a reflective liquid crystal display device.

In the case of the transmissive liquid crystal display device, a pixel electrode layer, a common electrode layer, a first substrate, a second substrate, and other components such as an insulating film and a conductive film, which are provided in a pixel region through which light is transmitted, have a property of transmitting light in the visible wavelength range. In the liquid crystal display device having the structure in which an electric field is applied in the lateral direction as illustrated in FIG. 2, it is preferable that the pixel electrode layer and the common electrode layer have a light-transmitting property; however, if an opening pattern is provided, a non-light-transmitting material such as a metal film may be used depending on the shape. Note that in this specification, a light-transmitting property refers to a property of transmitting at least light in the visible wavelength range.

On the other hand, in the case of the reflective liquid crystal display device, a reflective component which reflects light transmitted through the liquid crystal composition (e.g., a reflective film or substrate) may be provided on the side opposite to the viewing side of the liquid crystal composition. Therefore, a substrate, an insulating film, and a conductive film which are provided between the viewing side and the reflective component and through which light is transmitted have a light-transmitting property with respect to light in the visible wavelength range. In the liquid crystal display device having the structure in which an electric field is applied in the vertical direction illustrated in FIG. 3, the pixel electrode layer or the common electrode layer on the side opposite to the viewing side may have a light-reflecting property so that it can be used as a reflective component.

The pixel electrode layer 230 and the common electrode layer 232 may be formed with the use of one or more of the following: indium tin oxide (ITO), a conductive material in which zinc oxide (ZnO) is mixed into indium oxide, a conductive material in which silicon oxide (SiO₂) is mixed into indium oxide, organoindium, organotin, indium oxide containing tungsten oxide, indium zinc oxide containing tungsten oxide, indium oxide containing titanium oxide, and indium tin oxide containing titanium oxide; graphene; metals such as tungsten (W), molybdenum (Mo), zirconium (Zr), hafnium (HD, vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof. Alternatively, a conductive composition containing a conductive high molecule (also referred to as a conductive polymer) can be used to form the pixel electrode layer 230 and the common electrode layer 232. As the conductive high molecule, a π-electron conjugated conductive polymer can be used. For example, polyaniline or a derivative thereof, polypyrrole or a derivative thereof, polythiophene or a derivative thereof, and a copolymer of two or more kinds of them are given. The pixel electrode layer 230 and the common electrode layer 232 preferably have a sheet resistance of less than or equal to 10000 Ω/square and a light transmittance of greater than or equal to 70% at a wavelength of 550 nm. The resistivity of the conductive high molecule included in the conductive composition is preferably less than or equal to 0.1 Ω·cm. Accordingly, materials and structures of the electrodes are selected depending on a display mode of the liquid crystal display device as described above; for example, a material or a structure which transmits or reflects light is selected as appropriate.

As the first substrate 200 and the second substrate 201, a glass substrate of barium borosilicate glass, aluminoborosilicate glass, or the like, a quartz substrate, a plastic substrate, or the like can be used. Note that in the case of the reflective liquid crystal display device, a metal substrate such as an aluminum substrate or a stainless steel substrate may be used as a substrate on the side opposite to the viewing side.

With the use of the composite of a polymer and a liquid crystal showing the characteristic texture described in Embodiment 1 or the composite of a polymer and a liquid crystal with the half width of a reflectance spectrum greater than or equal to 30 nm and less than or equal to 60 nm, the liquid crystal display device can display high-contrast images.

Furthermore, the composite of a polymer and a liquid crystal according to one embodiment of the present invention can exhibit a blue phase and respond quickly. Therefore, by using the liquid crystal composition for a liquid crystal display device, a high-performance liquid crystal display device can be provided.

Note that an optical film such as a polarizing plate, a retardation plate, or an anti-reflection film may be provided as appropriate. In addition, a backlight or the like can be used as a light source.

The structures, methods, and the like described in this embodiment can be combined as appropriate with any of the other structures, methods, and the like described in the other embodiments.

### Embodiment 3

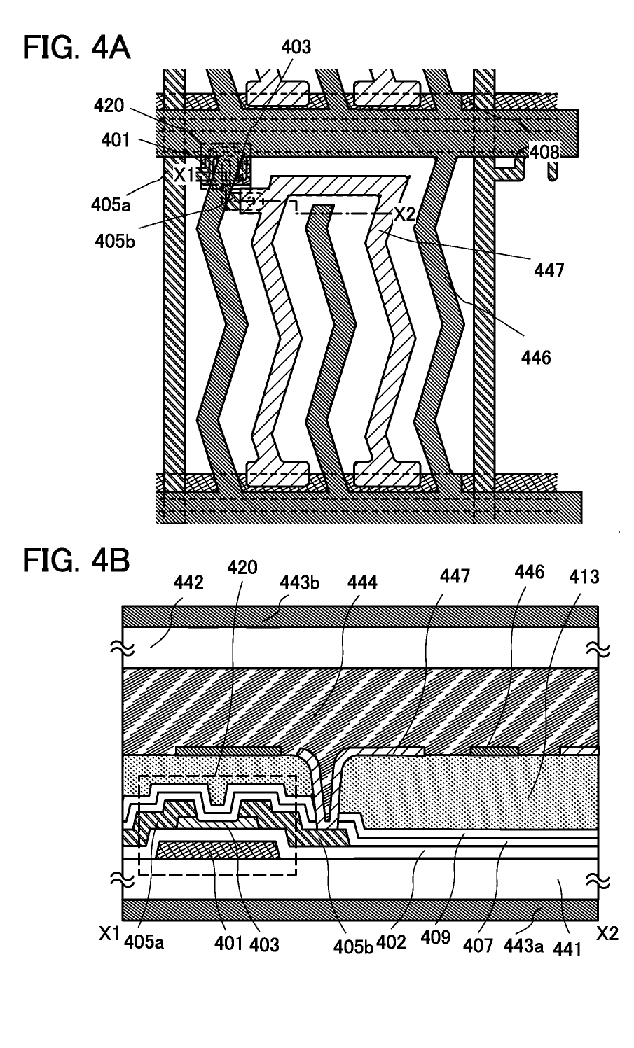

In this embodiment, a liquid crystal display device manufactured by using the composite of a polymer and a liquid crystal that is one embodiment of the present invention is described. The liquid crystal display device may be a passive-matrix liquid crystal display device or an active-matrix liquid crystal display device, and in this embodiment, the case where the composite of a polymer and a liquid crystal is applied to an active matrix liquid crystal display device is described with reference to FIGS. 4A and 4B.

FIG. 4A is a plan view of a liquid crystal display device and illustrates one pixel. FIG. 4B is a cross-sectional view taken along line X1-X2 of FIG. 4A.

In FIG. 4A, a plurality of source wiring layers (including the wiring layer 405a) are provided in parallel to each other (extended in the vertical direction in the drawing) and apart from each other. A plurality of gate wiring layers (including a gate electrode layer 401) are provided to be extended in a direction generally perpendicular to the source wiring layers (the horizontal direction in the drawing) and apart from each other. Common wiring layers 408 are provided adjacent to the respective plurality of gate wiring layers and extended in a direction generally parallel to the gate wiring layers, that is, in a direction generally perpendicular to the source wiring layers (the horizontal direction in the drawing). Roughly rectangular spaces are surrounded by the source wiring layers, the common wiring layers 408, and the gate wiring layers, and a pixel electrode layer and a common electrode layer of a liquid crystal display device are provided in these spaces. A transistor 420 for driving the pixel electrode layer is provided at an upper left corner of the drawing. A plurality of pixel electrode layers and a plurality of transistors are arranged in matrix.

In the liquid crystal display device of FIGS. 4A and 4B, the first electrode layer 447 which is electrically connected to the transistor 420 serves as a pixel electrode layer, while a second electrode layer 446 which is electrically connected to the common wiring layer 408 serves as a common electrode layer. Note that a capacitor is formed by the first electrode layer and the common wiring layer. Although a common electrode layer can operate in a floating state (an electrically isolated state), the potential of the common electrode layer may be set to a fixed potential, preferably to a potential around a common potential (an intermediate potential of image signals which are transmitted as data) in such a level as not to generate flickers.

Although there is no particular limitation on the positions of the electrodes, a method in which the gray scale is controlled by generation of an electric field generally parallel to a substrate to move liquid crystal molecules in a plane parallel to the substrate can be used. For such a method, an electrode structure used in an IPS mode illustrated in FIGS. 4A and 4B can be employed, for example.

The composite of a polymer and a liquid crystal showing the characteristic texture described in Embodiment 1 is used for a liquid crystal layer 444.

In a liquid crystal display device having the electrode structure illustrated in FIGS. 4A and 4B, liquid crystal of the liquid crystal layer 444 is controlled by an electric field generated between the first electrode layer 447 that is a pixel electrode layer and the second electrode layer 446 that is a common electrode layer. An electric field in the direction parallel to the substrate is formed for the liquid crystal, so that liquid crystal molecules can be controlled using the electric field. The liquid crystal molecules aligned to exhibit a blue phase can be controlled in the direction parallel to the substrate, whereby a wide viewing angle can be obtained.

Since the first electrode layer 447 and the second electrode layer 446 have an opening pattern, they are illustrated as divided plural electrode layers in the cross-sectional view of FIG. 4B. The same applies to the other drawings of this specification.

There is no particular limitation on a structure of a transistor which can be applied to a liquid crystal display device disclosed in this specification. For example, a staggered type transistor or a planar type transistor having a top-gate structure or a bottom-gate structure can be used. The transistor may have a single-gate structure including one channel formation region, a double-gate structure including two channel formation regions, or a triple-gate structure including three channel formation regions. Alternatively, the transistor may have a dual gate structure including two gate electrode layers positioned over and below a channel formation region with a gate insulating layer provided therebetween.

The transistor 420 illustrated in FIGS. 4A and 4B is an inverted staggered thin film transistor. The transistor 420 is formed over a first substrate 441 having an insulating surface, and includes the gate electrode layer 401, a gate insulating layer 402, a semiconductor layer 403, and the wiring layer 405a and a wiring layer 405b which function as a source electrode layer and a drain electrode layer. An insulating film 407 which covers the transistor 420 and is in contact with the semiconductor layer 403 and an insulating film 409 which covers the insulating film 407 are provided. The interlayer film 413 is stacked over the insulating film 409.

There is no particular limitation on the method for forming the interlayer film 413, and the following method can be employed depending on the material: spin coating, dip coating, spray coating, droplet discharging (such as ink jetting), screen printing, or offset printing, roll coating, curtain coating, knife coating, or the like.

The first substrate 441 and the second substrate 442 that is the counter substrate are fixed to each other with a sealant with the liquid crystal layer 444 interposed therebetween. The liquid crystal layer 444 can be formed by a dispenser method (a dropping method), or an injection method by which a liquid crystal composition for forming the composite of a polymer and a liquid crystal is injected using a capillary phenomenon or the like after the first substrate 441 is attached to the second substrate 442. After that, polymer stabilization treatment is performed by the method described in Embodiment 1, thereby obtaining the composite of a polymer and a liquid crystal showing the characteristic texture.

Note that in the case where polymer stabilization treatment is performed, the polymer stabilization treatment is performed at a temperature at which the liquid crystal composition exhibits an isotropic phase, whereby the occurrence of defective orientation generated near a display region in the liquid crystal display device can be suppressed.

As the sealant, it is preferable to use visible light curable, ultraviolet curable, or heat curable resin. Typically, an acrylic resin, an epoxy resin, an amine resin, or the like can be used. Further, a photopolymerization initiator (typically, an ultraviolet light polymerization initiator), a thermosetting agent, a filler, or a coupling agent may be included in the sealant.

In the case where an ultraviolet curable resin is used as a sealant and a liquid crystal composition is formed by a dropping method, for example, the sealant may be cured by the light irradiation step of the polymer stabilization treatment.

In this embodiment, a polarizing plate 443a is provided on the outer side of the first substrate 441 (on the side opposite to the liquid crystal layer 444), and a polarizing plate 443b is provided on the outer side of the second substrate 442 (on the side opposite to the liquid crystal layer 444). In addition to the polarizing plate, an optical film such as a retardation plate or an anti-reflection film may be provided. For example, circular polarization by the polarizing plate and the retardation plate may be used. Through the above-described process, a liquid crystal display device can be completed.

In the case of manufacturing a plurality of liquid crystal display devices using a large-sized substrate (a so-called multiple panel method), a division step can be performed before the polymer stabilization treatment or before provision of the polarizing plates. In consideration of the influence of the division step on the liquid crystal composition (such as alignment disorder due to force applied in the division step), it is preferable that the division step be performed after the attachment between the first substrate and the second substrate and before the polymer stabilization treatment.

Although not illustrated, a backlight, a sidelight, or the like may be used as a light source. Light from the light source is emitted from the side of the first substrate 441 which is an element substrate so as to pass through the second substrate 442 on the viewing side.

Materials of the first electrode layer 447 and the second electrode layer 446 can be the same as the materials of the pixel electrode layer 230 and the common electrode layer 232 described in Embodiment 2. Materials and structures of the electrodes are selected depending on a display mode of the liquid crystal display device as described above; for example, a material or a structure which transmits or reflects light is selected as appropriate.

An insulating film serving as a base film may be provided between the first substrate 441 and the gate electrode layer 401. The base film has a function of preventing diffusion of an impurity element from the first substrate 441, and can be formed to have a single-layer structure or a stacked-layer structure using one or more of a silicon nitride film, a silicon oxide film, a silicon nitride oxide film, and a silicon oxynitride film. The gate electrode layer 401 can be formed to have a single-layer or a stacked-layer structure using a metal material such as molybdenum, titanium, chromium, tantalum, tungsten, aluminum, copper, neodymium, or scandium, or an alloy material which contains any of these materials as its main component. A semiconductor film which is doped with an impurity element such as phosphorus and is typified by a polycrystalline silicon film, or a silicide film of nickel silicide or the like can also be used as the gate electrode layer 401. By using a light-blocking conductive film as the gate electrode layer 401, light from a backlight (light emitted through the first substrate 441) can be prevented from entering the semiconductor layer 403.

For example, the gate insulating layer 402 can be formed by a plasma CVD method or a sputtering method, with the use of a silicon oxide film, a gallium oxide film, an aluminum oxide film, a silicon nitride film, a silicon oxynitride film, an aluminum oxynitride film, or a silicon nitride oxide film. Alternatively, a high-k material such as hafnium oxide, yttrium oxide, lanthanum oxide, hafnium silicate, hafnium aluminate, hafnium silicate to which nitrogen is added, or hafnium aluminate to which nitrogen is added may be used as a material for the gate insulating layer 402. The use of such a high-k material enables a reduction in gate leakage current.

A material of the semiconductor layer 403 is not limited to a particular material and may be determined in accordance with characteristics needed for the transistor 420, as appropriate. Examples of a material which can be used for the semiconductor layer 403 will be described.

The semiconductor layer 403 can be formed using the following material: an amorphous semiconductor formed by a sputtering method or a vapor-phase growth method using a semiconductor source gas typified by silane or germane; a polycrystalline semiconductor formed by crystallizing the amorphous semiconductor with the use of light energy or thermal energy; a microcrystalline semiconductor; or the like. The semiconductor layer can be formed by a sputtering method, an LPCVD method, a plasma CVD method, or the like.

As a typical example of an amorphous semiconductor, hydrogenated amorphous silicon can be given, and as a typical example of a crystalline semiconductor, polysilicon or the like can be given. Examples of polysilicon (polycrystalline silicon) include so-called high-temperature polysilicon which contains polysilicon formed at a process temperature of 800° C. or more as the main component, so-called low-temperature polysilicon which contains polysilicon formed at a process temperature of 600° C. or less as the main component, polysilicon obtained by crystallizing amorphous silicon by using an element that promotes crystallization or the like, and the like. Needless to say, as described above, a microcrystalline semiconductor, or a semiconductor which includes a crystalline phase in part of a semiconductor layer can be used.

Alternatively, an oxide semiconductor may be used. In that case, any of the following can be used: an indium oxide; a tin oxide; zinc oxide; an In—Zn-based oxide, a Sn—Zn-based oxide, an Al—Zn-based oxide, a Zn—Mg-based oxide, a Sn—Mg-based oxide, an In—Mg-based oxide, or an In—Ga-based oxide; an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, or an In—Lu—Zn-based oxide; or an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide. In addition, any of the above oxide semiconductors may contain an element other than In, Ga, Sn, and Zn, for example, SiO₂.

Here, for example, an In—Ga—Zn-based oxide semiconductor means an oxide semiconductor containing indium (In), gallium (Ga), and zinc (Zn), and there is no limitation on the composition thereof.

A c-axis aligned crystalline oxide semiconductor (CAAC-OS) film can be used for the semiconductor layer 403. The CAAC-OS is not completely single crystal nor completely amorphous. In the crystal parts included in the CAAC-OS film, c-axes are aligned in the direction parallel (including the range of −5° to 5°) to a normal vector of the surface where the CAAC-OS film is formed or a normal vector of the surface of the CAAC-OS film, a triangular or hexagonal atomic arrangement is provided when seen from the direction perpendicular (including the range of 85° to 95°) to an a-b plane, and metal atoms are arranged in a layered manner or metal atoms and oxygen atoms are arranged in a layered manner when seen from the direction perpendicular (including the range of 85° to 95°) to the c-axis. Note that, among the crystal parts, the directions of the a-axis and the b-axis of one crystal part may be different from those of another crystal part.

In a process of forming the semiconductor layer and the wiring layer, an etching step is used to process thin films into desired shapes. Dry etching or wet etching can be used for the etching step.

The etching conditions (such as an etchant, etching time, and temperature) are appropriately adjusted depending on the material so that the material can be etched into a desired shape.

As a material of the wiring layers 405a and 405b serving as source or drain electrode layers, an element selected from Al, Cr, Ta, Ti, Mo, and W; an alloy containing any of the above elements as its component; an alloy film containing these elements in combination; and the like can be given. Further, in the case where heat treatment is performed, the conductive film preferably has heat resistance against the heat treatment. Since use of Al alone brings disadvantages such as low heat resistance and a tendency to corrosion, aluminum is used in combination with a conductive material having heat resistance. As the conductive material having heat resistance, which is combined with Al, it is possible to use an element selected from titanium (Ti), tantalum (Ta), tungsten (W), molybdenum (Mo), chromium (Cr), neodymium (Nd), and scandium (Sc), an alloy containing any of these elements as its component, an alloy containing a combination of any of these elements, a nitride containing any of these elements as its component, or a stacked layer of any of these elements.

As the insulating film 407 and the insulating film 409 which cover the transistor 420, an inorganic insulating film or an organic insulating film formed by a dry method or a wet method can be used. For example, it is possible to use a silicon nitride film, a silicon oxide film, a silicon oxynitride film, an aluminum oxide film, or a tantalum oxide film, which is formed by a CVD method, a sputtering method, or the like. Alternatively, an organic material such as a polyimide resin, an acrylic resin, a benzocyclobutene-based resin, a polyamide resin, or an epoxy resin can be used. Other than such organic materials, it is also possible to use a low-dielectric constant material (a low-k material), a siloxane-based resin, PSG (phosphosilicate glass), BPSG (borophosphosilicate glass), or the like. A gallium oxide film can also be used as the insulating film 407.

Alternatively, the insulating film 407 and the insulating film 409 may be formed by stacking plural insulating films formed using any of these materials. For example, an organic resin film may be stacked over an inorganic insulating film.

As described above, with the use of the composite of a polymer and a liquid crystal showing the characteristic texture described in Embodiment 1 for a liquid crystal element or a liquid crystal display device, a liquid crystal element or a liquid crystal display device with high contrast can be provided. Accordingly, a high-definition liquid crystal display device can be provided.

Furthermore, the composite of a polymer and a liquid crystal showing the characteristic texture described in Embodiment 1 exhibits a blue phase and thus is capable of high-speed response. Consequently, by using the composite of a polymer and a liquid crystal for a liquid crystal display device, a high-performance liquid crystal display device can be provided.

The structures, methods, and the like described in this embodiment can be combined as appropriate with any of the other structures, methods, and the like described in the other embodiments.

### Embodiment 4

With the use of transistors, part or the whole of the driver circuit can be formed over the same substrate as the pixel portion, whereby a system-on-panel can be obtained.

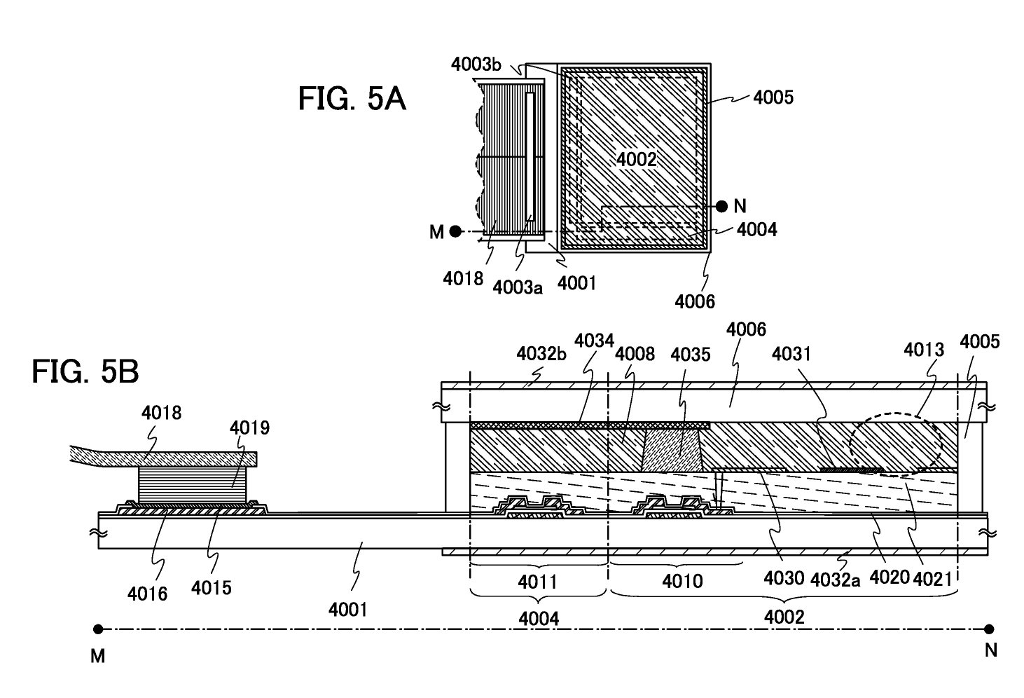

The appearance and a cross section of a liquid crystal display panel, which is one embodiment of a liquid crystal display device, will be described with reference to FIGS. 5A and 5B. FIG. 5A is a top view of a panel in which transistors 4010 and 4011 formed over a first substrate 4001 and a liquid crystal element 4013 are sealed between the first substrate 4001 and a second substrate 4006 with a sealant 4005. FIG. 5B is a cross-sectional view taken along the line M-N of FIG. 5A.

The sealant 4005 is provided to surround a pixel portion 4002 and a scan line driver circuit 4004 that are provided over the first substrate 4001. The second substrate 4006 is provided over the pixel portion 4002 and the scan line driver circuit 4004. Therefore, the pixel portion 4002 and the scan line driver circuit 4004 are sealed together with a liquid crystal layer 4008, by the first substrate 4001, the sealant 4005, and the second substrate 4006.

In FIG. 5A, a signal line driver circuit that is formed using a single crystal semiconductor film or a polycrystalline semiconductor film over a substrate separately prepared is mounted in a region different from the region surrounded by the sealant 4005 over the first substrate 4001. Note that FIG. 5A illustrates an example in which part of the signal line driver circuit is formed using a transistor provided over the first substrate 4001. A signal line driver circuit 4003b is formed over the first substrate 4001, and a signal line driver circuit 4003a formed using a single crystal semiconductor film or a polycrystalline semiconductor film is mounted on a substrate separately prepared.

Note that the connection method of a driver circuit which is separately formed is not particularly limited, and a COG method, a wire bonding method, a TAB method, or the like can be used. FIG. 5A shows an example where the signal line driver circuit 4003a is provided by a TAB method.

The pixel portion 4002 and the scan line driver circuit 4004 provided over the first substrate 4001 each include a plurality of transistors. FIG. 5B illustrates the transistor 4010 included in the pixel portion 4002 and the transistor 4011 included in the scan line driver circuit 4004. An insulating layer 4020 and an interlayer film 4021 are provided over the transistors 4010 and 4011.

As the transistors 4010 and 4011, the transistor which is described in Embodiment 2 can be employed.

Furthermore, a conductive layer may be provided over the interlayer film 4021 or the insulating layer 4020 so as to overlap with a channel formation region of a semiconductor layer of the transistor 4011 for the driver circuit. The conductive layer may have a potential the same as or different from that of a gate electrode layer of the transistor 4011 and can function as a second gate electrode layer. Furthermore, the potential of the conductive layer may be GND, 0 V, or the conductive layer may be in a floating state.

A pixel electrode layer 4030 and a common electrode layer 4031 are provided over the interlayer film 4021, and the pixel electrode layer 4030 is electrically connected to the transistor 4010. The liquid crystal element 4013 includes the pixel electrode layer 4030, the common electrode layer 4031, and the liquid crystal layer 4008. Note that a polarizing plate 4032a and a polarizing plate 4032b are provided on the outer sides of the first substrate 4001 and the second substrate 4006, respectively.

The composite of a polymer and a liquid crystal showing the characteristic texture described in Embodiment 1 or a composite of a polymer and a liquid crystal with the half width of a reflectance spectrum greater than or equal to 30 nm and less than or equal to 60 nm is used for the liquid crystal layer 4008. The structures of the pixel electrode layer and the common electrode layer described in the above embodiment can be used as the pixel electrode layer 4030 and the common electrode layer 4031.

In this embodiment, the liquid crystal layer 4008 includes the composite of a polymer and a liquid crystal showing the characteristic texture or a composite of a polymer and a liquid crystal with the half width of a reflectance spectrum greater than or equal to 30 nm and less than or equal to 60 nm, and the liquid crystal layer 4008 is provided in a liquid crystal display device with a blue phase exhibited (in a state where a blue phase appears or a state where a blue phase is shown).

With an electric field generated between the pixel electrode layer 4030 and the common electrode layer 4031, liquid crystal of the liquid crystal layer 4008 is controlled. An electric field in the direction parallel to the substrate is formed in the liquid crystal, so that liquid crystal molecules can be controlled using the electric field. Since the liquid crystal molecules aligned to exhibit a blue phase can be controlled in the direction parallel to the substrate, a wide viewing angle is obtained.

As the first substrate 4001 and the second substrate 4006, glass, plastic, or the like having a light-transmitting property can be used. As plastic, a fiberglass-reinforced plastics (FRP) plate, a polyvinyl fluoride (PVF) film, a polyester film, or an acrylic resin film can be used. A sheet with a structure in which an aluminum foil is sandwiched between PVF films or polyester films can also be used.

A spacer 4035 is a columnar spacer obtained by selective etching of an insulating film and is provided in order to control the thickness of the liquid crystal layer 4008 (a cell gap). Alternatively, a spherical spacer may be used. In the liquid crystal display device including the liquid crystal layer 4008, the cell gap which is the thickness of the liquid crystal layer is preferably greater than or equal to 1 μm and less than or equal to 20 μm. In this specification, the thickness of a cell gap refers to the maximum thickness (film thickness) of a liquid crystal layer.

Although FIGS. 5A and 5B illustrate examples of transmissive liquid crystal display devices, one embodiment of the present invention can also be applied to a transflective liquid crystal display device and a reflective liquid crystal display device.

FIGS. 5A and 5B illustrate examples of liquid crystal display devices in which a polarizing plate is provided on the outer side (the viewing side) of a substrate; however, the polarizing plate may be provided on the inner side of the substrate. The position of the polarizing plate may be determined as appropriate depending on the material of the polarizing plate and conditions of the manufacturing process. Furthermore, a light-blocking layer serving as a black matrix may be provided.

A color filter layer or a light-blocking layer may be formed as part of the interlayer film 4021. In FIGS. 5A and 5B, a light-blocking layer 4034 is provided on the second substrate 4006 side so as to cover the transistors 4010 and 4011. By providing the light-blocking layer 4034, the contrast can be more increased and the transistors can be more stabilized.

The transistors may be, but is not necessarily, covered with the insulating layer 4020 which functions as a protective film of the transistors.

Note that the protective film is provided to prevent entry of contaminant impurities such as an organic substance, metal, and moisture in the air and is preferably a dense film. The protective film may be formed by a sputtering method to have a single-layer structure or a layered structure including any of a silicon oxide film, a silicon nitride film, a silicon oxynitride film, a silicon nitride oxide film, an aluminum oxide film, an aluminum nitride film, an aluminum oxynitride film, and an aluminum nitride oxide film.

Furthermore, in the case of further forming a light-transmitting insulating layer as a planarizing insulating film, the light-transmitting insulating layer can be formed using an organic material having heat resistance, such as a polyimide resin, an acrylic resin, a benzocyclobutene-based resin, a polyamide resin, or an epoxy resin. As an alternative to such organic materials, it is possible to use a low-dielectric constant material (a low-k material), a siloxane-based resin, phosphosilicate glass (PSG), borophosphosilicate glass (BPSG), or the like. The insulating layer may be formed by stacking a plurality of insulating films formed of these materials.

Materials of the pixel electrode layer 4030 and the common electrode layer 4031 can be the same as the materials of the pixel electrode layer 230 and the common electrode layer 232 described in Embodiment 2.

Furthermore, a variety of signals and potentials are supplied to the signal line driver circuit which is formed separately, the scan line driver circuit 4004, or the pixel portion 4002 from an FPC 4018.

Furthermore, since the transistor is easily broken by static electricity or the like, a protective circuit for protecting the driver circuits is preferably provided over the same substrate as a gate line or a source line. The protection circuit is preferably formed using a nonlinear element.

In FIGS. 5A and 5B, a connection terminal electrode 4015 is formed using the same conductive film as the pixel electrode layer 4030, and a terminal electrode 4016 is formed using the same conductive film as source electrode layers and drain electrode layers of the transistors 4010 and 4011.

The connection terminal electrode 4015 is electrically connected to a terminal of the FPC 4018 through an anisotropic conductive film 4019.

Although FIGS. 5A and 5B illustrate examples in which the signal line driver circuit is formed separately and mounted on the first substrate 4001, one embodiment of the present invention is not limited to this structure. The scan line driver circuit may be separately formed and then mounted, or only part of the signal line driver circuit or part of the scan line driver circuit may be separately formed and then mounted.

As described above, with the use of the composite of a polymer and a liquid crystal showing the characteristic texture described in Embodiment 1 for a liquid crystal element or a liquid crystal display device, a liquid crystal element or a liquid crystal display device with high contrast can be provided. Accordingly, a high-definition liquid crystal display device can be provided.

Furthermore, the composite of a polymer and a liquid crystal showing the characteristic texture described in Embodiment 1 exhibits a blue phase and thus is capable of high-speed response. Consequently, by using the composite of a polymer and a liquid crystal for a liquid crystal display device, a high-performance liquid crystal display device can be provided.

The structures, methods, and the like described in this embodiment can be combined as appropriate with any of the other structures, methods, and the like described in the other embodiments.

### Embodiment 5

Examples of the electronic devices to which the above liquid crystal display device is applied are television sets (also referred to as televisions or television receivers), monitors of computers or the like, cameras such as digital cameras or digital video cameras, digital photo frames, mobile phone sets (also referred to as mobile phones or mobile phone devices), portable game machines, portable information terminals, audio reproducing devices, large-sized game machines such as pachinko machines, and the like. Specific examples of these electronic devices are described below.

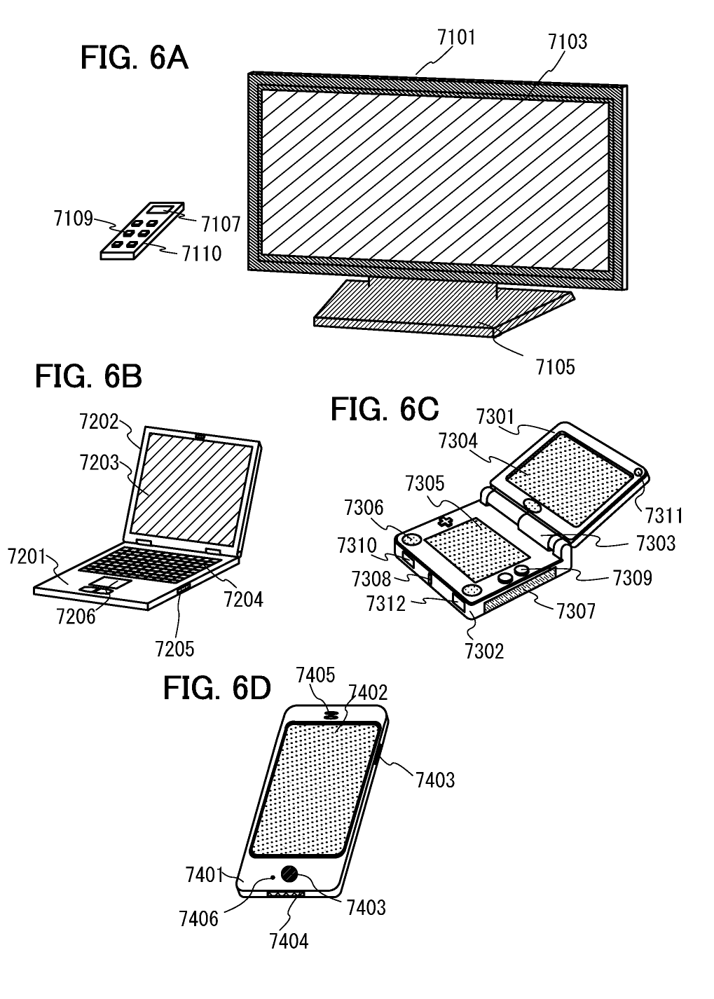

FIG. 6A illustrates an example of a television set. In the television set, a display portion 7103 is incorporated in a housing 7101. In addition, here, the housing 7101 is supported by a stand 7105. The display portion 7103 enables images to be displayed and includes liquid crystal elements, which are arranged in a matrix, each including the composite of a polymer and a liquid crystal showing the characteristic texture described in Embodiment 1. Accordingly, the television set including the display portion 7103 can be a high-contrast television set. Furthermore, the television set can be a high-performance television set capable of quick response.

Operation of the television set can be performed with an operation switch of the housing 7101 or a separate remote control 7110. With operation keys 7109 of the remote control 7110, channels and volume can be controlled and images displayed on the display portion 7103 can be controlled. Furthermore, the remote control 7110 may be provided with a display portion 7107 for displaying data output from the remote control 7110.

Note that the television set is provided with a receiver, a modem, and the like. With the receiver, a general television broadcast can be received. Furthermore, when the television set is connected to a communication network by wired or wireless connection via the modem, one-way (from a transmitter to a receiver) or two-way (between a transmitter and a receiver, between receivers, or the like) data communication can be performed.

FIG. 6B illustrates a computer having a main body 7201, a housing 7202, a display portion 7203, a keyboard 7204, an external connection port 7205, a pointing device 7206, and the like. Note that this computer is manufactured by using liquid crystal elements, which are arranged in a matrix, each including the composite of a polymer and a liquid crystal showing the characteristic texture described in Embodiment 1 for the display portion 7203.

FIG. 6C illustrates a portable game machine having two housings, a housing 7301 and a housing 7302, which are connected with a joint portion 7303 so that the portable game machine can be opened or folded. A display portion 7304 includes liquid crystal elements, which are arranged in a matrix, each including the composite of a polymer and a liquid crystal showing the characteristic texture described in Embodiment 1 and is incorporated in the housing 7301, and a display portion 7305 is incorporated in the housing 7302. In addition, the portable game machine illustrated in FIG. 6C includes a speaker portion 7306, a recording medium insertion portion 7307, an LED lamp 7308, input means (an operation key 7309, a connection terminal 7310, a sensor 7311 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), and a microphone 7312), and the like. It is needless to say that the structure of the portable game machine is not limited to the above as far as liquid crystal elements, which are arranged in a matrix, each including the composite of a polymer and a liquid crystal showing the characteristic texture described in Embodiment 1 is used for either the display portion 7304 or the display portion 7305, or both. The structure can include another accessory as appropriate. The portable game machine illustrated in FIG. 6C has a function of reading out a program or data stored in a storage medium to display it on the display portion, and a function of sharing information with another portable game machine by wireless communication. The portable game machine illustrated in FIG. 6C can have a variety of functions without limitation to the above. Since the liquid crystal elements used in the display portion 7304 includes the composite of a polymer and a liquid crystal showing the characteristic texture described in Embodiment 1, the above-described portable game machine including the display portion 7304 can be a high-contrast portable game machine. Thus, a portable game machine with high image quality can be provided. Furthermore, a high-performance portable game machine can be provided.

FIG. 6D illustrates an example of a mobile phone. A mobile phone is provided with a display portion 7402 incorporated in a housing 7401, operation buttons 7403, an external connection port 7404, a speaker 7405, a microphone 7406, and the like. Note that the mobile phone is manufactured using the light-emitting device for the display portion 7402. Note that the cellular phone has the display portion 7402 including liquid crystal elements arranged in a matrix, each including the composite of a polymer and a liquid crystal showing the characteristic texture described in Embodiment 1. Accordingly, the cellular phone that has the display portion 7402 including the liquid crystal elements can be a cellular phone having high image quality with high contrast. Furthermore, a high-performance cellular phone can be provided.

When the display portion 7402 of the mobile phone illustrated in FIG. 6D is touched with a finger or the like, data can be input to the mobile phone. In this case, operations such as making a call and creating mail can be performed by touching the display portion 7402 with a finger or the like.

There are mainly three screen modes of the display portion 7402. The first mode is a display mode mainly for displaying images. The second mode is an input mode mainly for inputting data of a character and the like. The third mode is a display-and-input mode in which two modes of the display mode and the input mode are combined.

For example, in the case of making a call or creating an e-mail, an input mode mainly for inputting a character is selected for the display portion 7402 so that a character displayed on the screen can be input. In this case, it is preferable to display a keyboard or number buttons on almost the entire screen of the display portion 7402.

When a detection device including a sensor for detecting inclination, such as a gyroscope or an acceleration sensor, is provided inside the mobile phone, display on the screen of the display portion 7402 can be automatically switched by determining the orientation of the mobile phone (whether the mobile phone is placed horizontally or vertically for a landscape mode or a portrait mode).

The screen modes are switched by touching the display portion 7402 or operating the operation buttons 7403 of the housing 7401. The screen modes can also be switched depending on the kind of image displayed on the display portion 7402. For example, when a signal of an image displayed on the display portion is a signal of moving image data, the screen mode is switched to the display mode. When the signal is a signal of text data, the screen mode is switched to the input mode.

Moreover, in the input mode, when input by touching the display portion 7402 is not performed for a certain period while a signal detected by an optical sensor in the display portion 7402 is detected, the screen mode may be controlled so as to be switched from the input mode to the display mode.

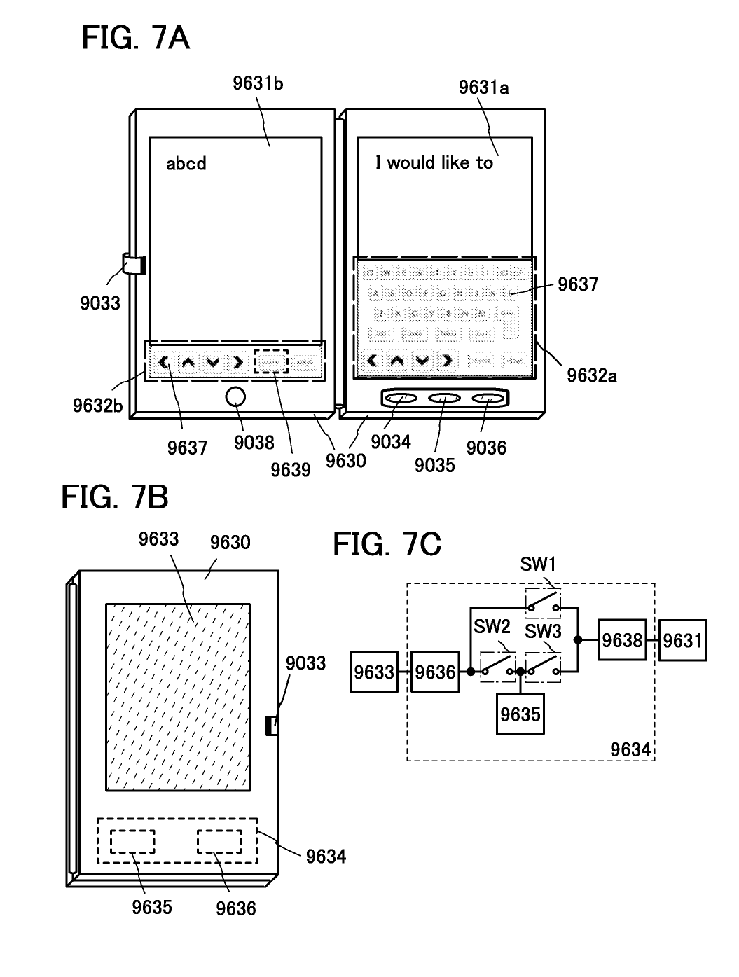

FIGS. 7A and 7B illustrate an example of a foldable tablet terminal. FIG. 7A illustrates the tablet terminal which is unfolded. The tablet terminal includes a housing 9630, a display portion 9631a, a display portion 9631b, a display mode switch 9034, a power switch 9035, a power-saving mode switch 9036, a clasp 9033, and an operation switch 9038. Note that in the tablet terminal, at least one of the display portion 9631a and the display portion 9631b is formed using a liquid crystal display device provided with a liquid crystal element including the composite of a polymer and a liquid crystal showing the characteristic texture described in Embodiment 1.

Part of the display portion 9631a can be a touchscreen region 9632a and data can be input when a displayed operation key 9637 is touched. Although half of the display portion 9631a has only a display function and the other half has a touchscreen function, one embodiment of the present invention is not limited to the structure. The whole display portion 9631a may have a touchscreen function. For example, a keyboard is displayed on the entire region of the display portion 9631a so that the display portion 9631a is used as a touchscreen; thus, the display portion 9631b can be used as a display screen.

Like the display portion 9631a, part of the display portion 9631b can be a touchscreen region 9632b. When a switching button 9639 for showing/hiding a keyboard on the touchscreen is touched with a finger, a stylus, or the like, the keyboard can be displayed on the display portion 9631b.

Touch input can be performed in the touchscreen region 9632a and the touchscreen region 9632b at the same time.

The display mode switch 9034 can switch the display between portrait mode, landscape mode, and the like, and between monochrome display and color display, for example. The power-saving switch 9036 can control display luminance in accordance with the amount of external light in use of the tablet terminal detected by an optical sensor incorporated in the tablet terminal. Another detection device including a sensor for detecting inclination, such as a gyroscope or an acceleration sensor, may be incorporated in the tablet terminal, in addition to the optical sensor.

Although FIG. 7A illustrates an example in which the display portion 9631a and the display portion 9631b have the same display area, one embodiment of the present invention is not limited to the example. The display portion 9631a and the display portion 9631b may have different display areas and different display quality. For example, one display panel may be capable of higher-definition display than the other display panel.

FIG. 7B illustrates the tablet terminal which is folded. The tablet terminal includes the housing 9630, a solar cell 9633, a charge and discharge control circuit 9634, a battery 9635, and a DC-to-DC converter 9636. As an example, FIG. 7B illustrates the charge and discharge control circuit 9634 including the battery 9635 and the DC-to-DC converter 9636.

Since the tablet terminal is foldable, the housing 9630 can be closed when the tablet terminal is not in use. As a result, the display portion 9631a and the display portion 9631b can be protected, thereby providing a tablet terminal with high endurance and high reliability for long-term use.

The tablet terminal illustrated in FIGS. 7A and 7B can have other functions such as a function of displaying various kinds of data (e.g., a still image, a moving image, and a text image), a function of displaying a calendar, a date, the time, or the like on the display portion, a touch-input function of operating or editing the data displayed on the display portion by touch input, and a function of controlling processing by various kinds of software (programs).

The solar cell 9633 provided on a surface of the tablet terminal can supply power to the touchscreen, the display portion, a video signal processing portion, or the like. Note that the solar cell 9633 is preferably provided on one or two surfaces of the housing 9630, in which case the battery 9635 can be charged efficiently.

The structure and operation of the charge and discharge control circuit 9634 illustrated in FIG. 7B will be described with reference to a block diagram of FIG. 7C. FIG. 7C illustrates the solar cell 9633, the battery 9635, the DC-to-DC converter 9636, a converter 9638, switches SW1 to SW3, and the display portion 9631. The battery 9635, the DC-to-DC converter 9636, the converter 9638, and the switches SW1 to SW3 correspond to the charge and discharge control circuit 9634 illustrated in FIG. 7B.

First, description is made on an example of the operation in the case where power is generated by the solar cell 9633 with the use of external light. The voltage of the power generated by the solar cell is raised or lowered by the DC-to-DC converter 9636 so as to be voltage for charging the battery 9635. Then, when power supplied from the battery 9635 charged by the solar cell 9633 is used for the operation of the display portion 9631, the switch SW 1 is turned on and the voltage of the power is raised or lowered by the converter 9638 so as to be voltage needed for the display portion 9631. When images are not displayed on the display portion 9631, the switch SW1 is turned off and the switch SW2 is turned on so that the battery 9635 is charged.

Although the solar cell 9633 is described as an example of a power generation means, the power generation means is not particularly limited, and the battery 9635 may be charged by another power generation means such as a piezoelectric element or a thermoelectric conversion element (Peltier element). The battery 9635 may be charged by a non-contact power transmission module which is capable of charging by transmitting and receiving power by wireless (without contact), or another charge means used in combination, and the power generation means is not necessarily provided.

Needless to say, one embodiment of the present invention is not limited to the electronic device having the shape illustrated in FIGS. 7A to 7C as long as the display portion 9631a or 9631b is included.

### Example 1

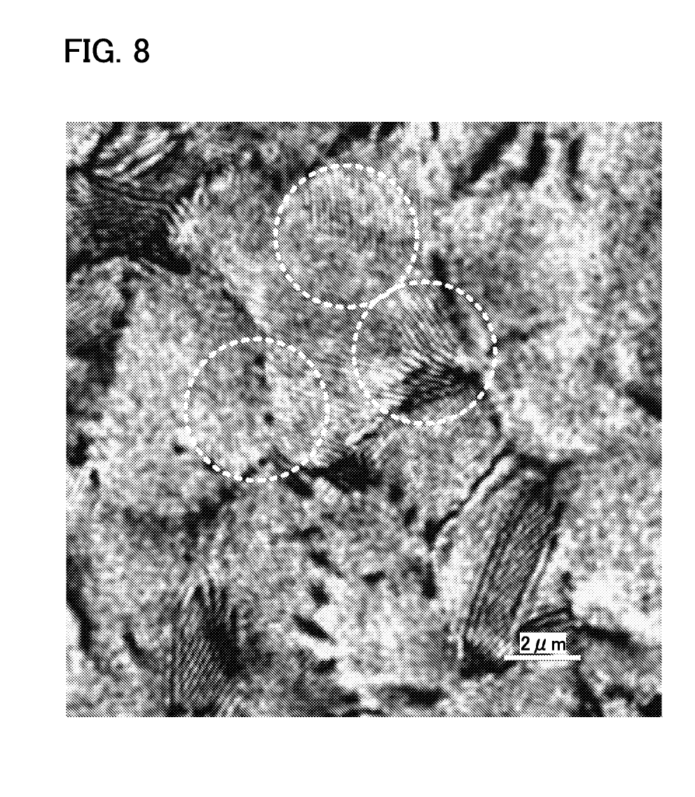

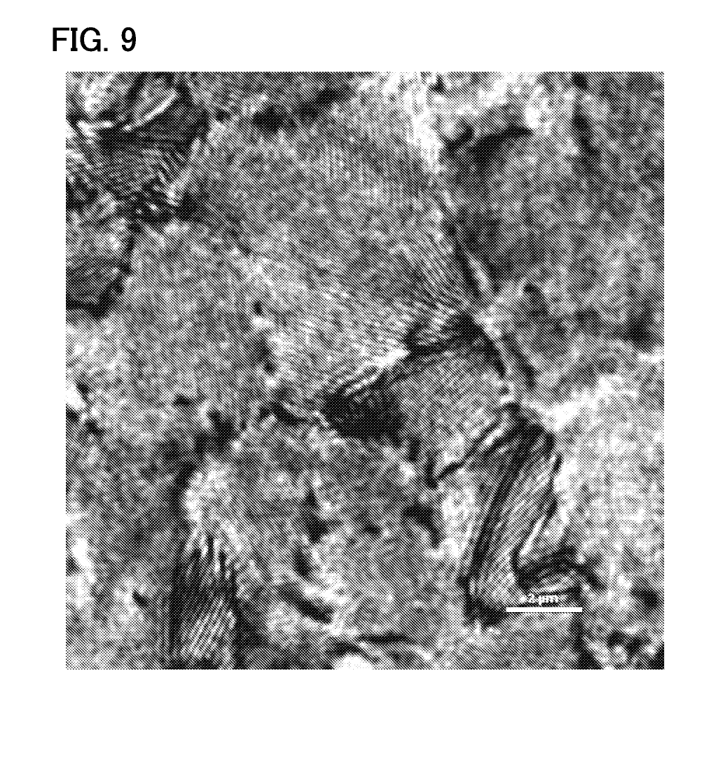

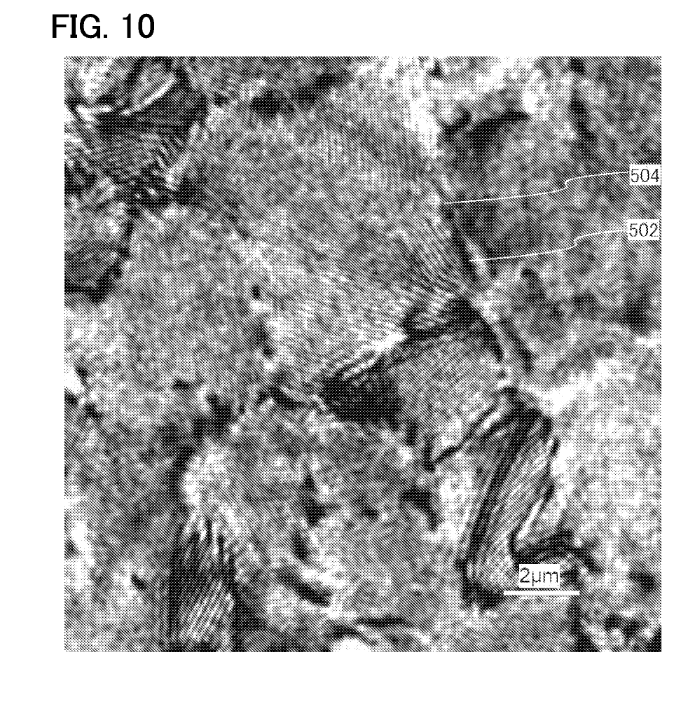

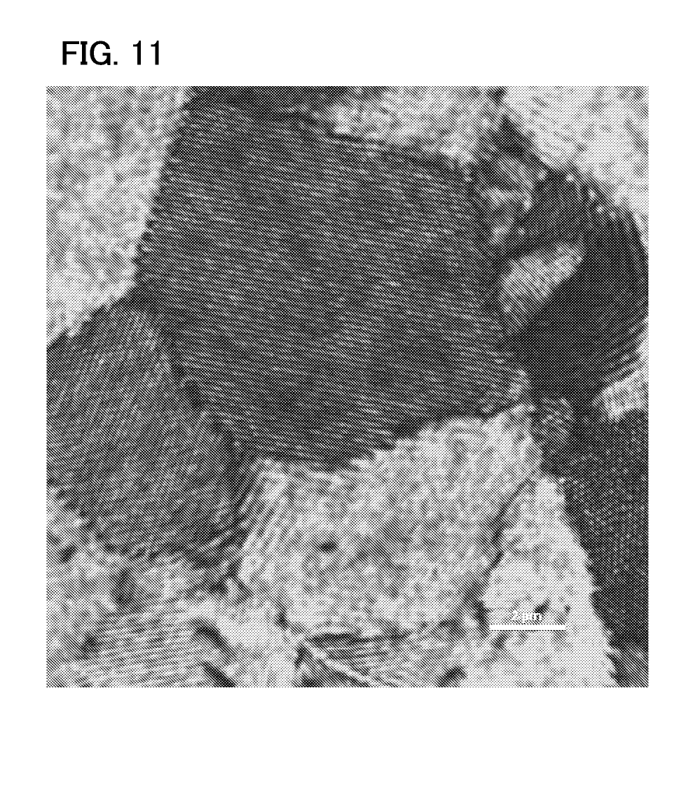

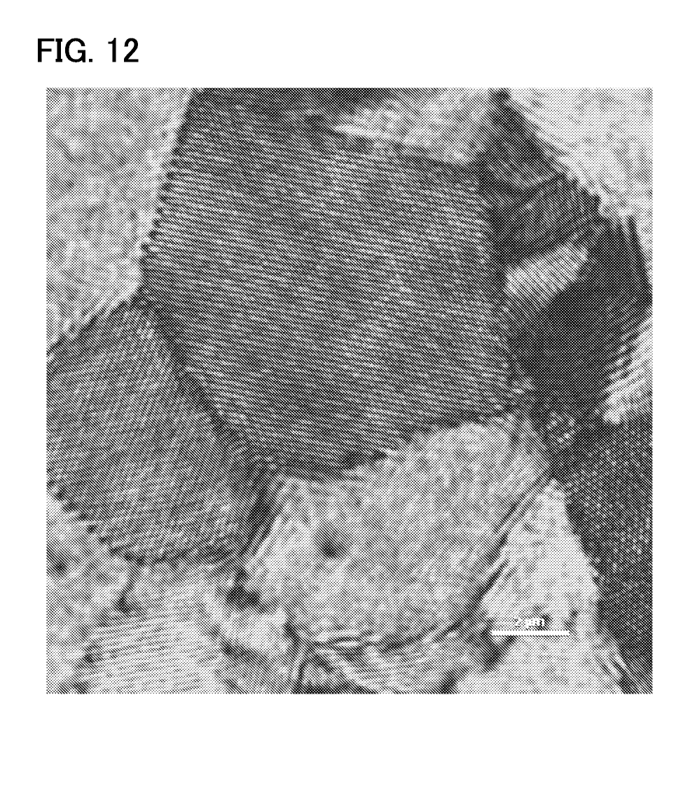

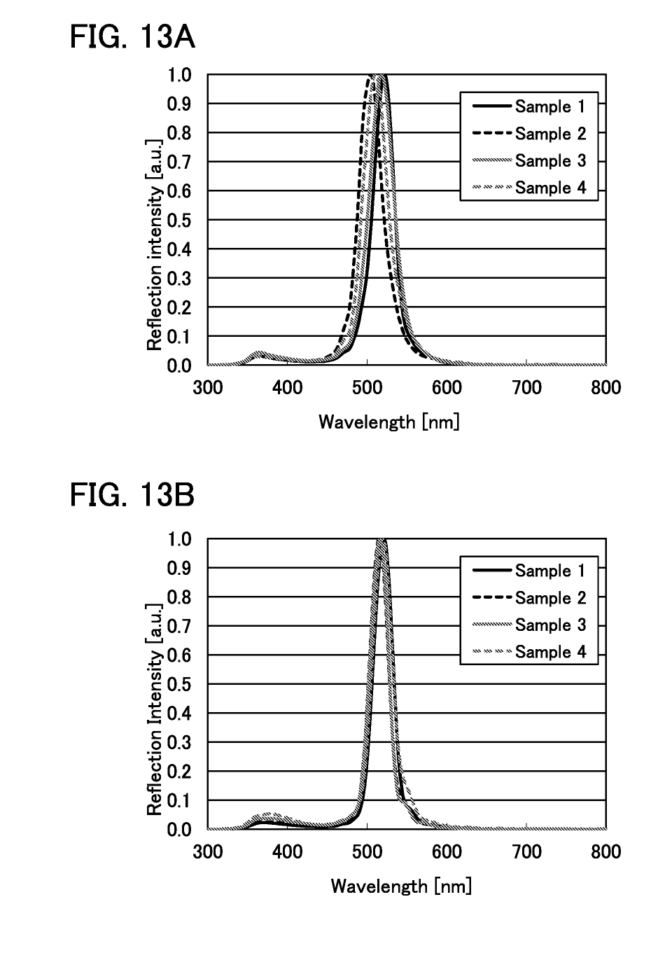

In this example, an example of the composite of a polymer and a liquid crystal according to one embodiment of the present invention will be described with reference to FIG. 8, FIG. 9, FIG. 10, FIG. 11, FIG. 12, and FIGS. 13A and 13B. Note that the composite of a polymer and a liquid crystal according to one embodiment of the present invention was formed under conditions A, and a comparative composite of a polymer and a liquid crystal was formed under conditions B. For evaluation, the formed composites of a polymer and a liquid crystal were observed with a confocal laser microscope and reflectance spectra of the composites of a polymer and a liquid crystal were measured. The composite of a polymer and a liquid crystal formed under the conditions A was subjected to some observations (observation 1 and observation 2) with a confocal laser microscope.

### <Conditions A>

### (Liquid Crystal Composition)

A liquid crystal composition used for the composite of a polymer and a liquid crystal formed under the conditions A includes E-8 (abbreviation) (produced by LCC Corporation), 4-(trans-4-n-propylcyclohexyl)-3′,4′-difluoro-1,1′-biphenyl (abbreviation: CPP-3FF), and 4-n-pentylbenzoic acid 4-cyano-3-fluorophenyl ester (abbreviation: PEP-5CNF) as a liquid crystal material exhibiting a blue phase, 1,4-bis-[4-(6-acryloyloxy-n-hexyl-1-oxy)benzoyloxy]-2-methylbenzene (abbreviation: RM257-O6) (produced by SYNTHON Chemicals GmbH & Co. KG) as a liquid-crystalline monomer, dodecyl methacrylate (abbreviation: DMeAc) (produced by Tokyo Chemical Industry Co., Ltd.) as a non-liquid-crystalline monomer, 2,2-dimethoxy-2-phenylacetophenone (abbreviation: DMPAP) (produced by Tokyo Chemical Industry Co., Ltd) as a polymerization initiator, and 1,4:3,6-dianhydro-2,5-bis[4-(n-hexyl-1-oxy)benzoic acid] sorbitol (abbreviation: ISO-(60BA)₂) (produced by Midori Kagaku Co., Ltd.) as a chiral material.

The structural formulae of the above-described substances are shown below.

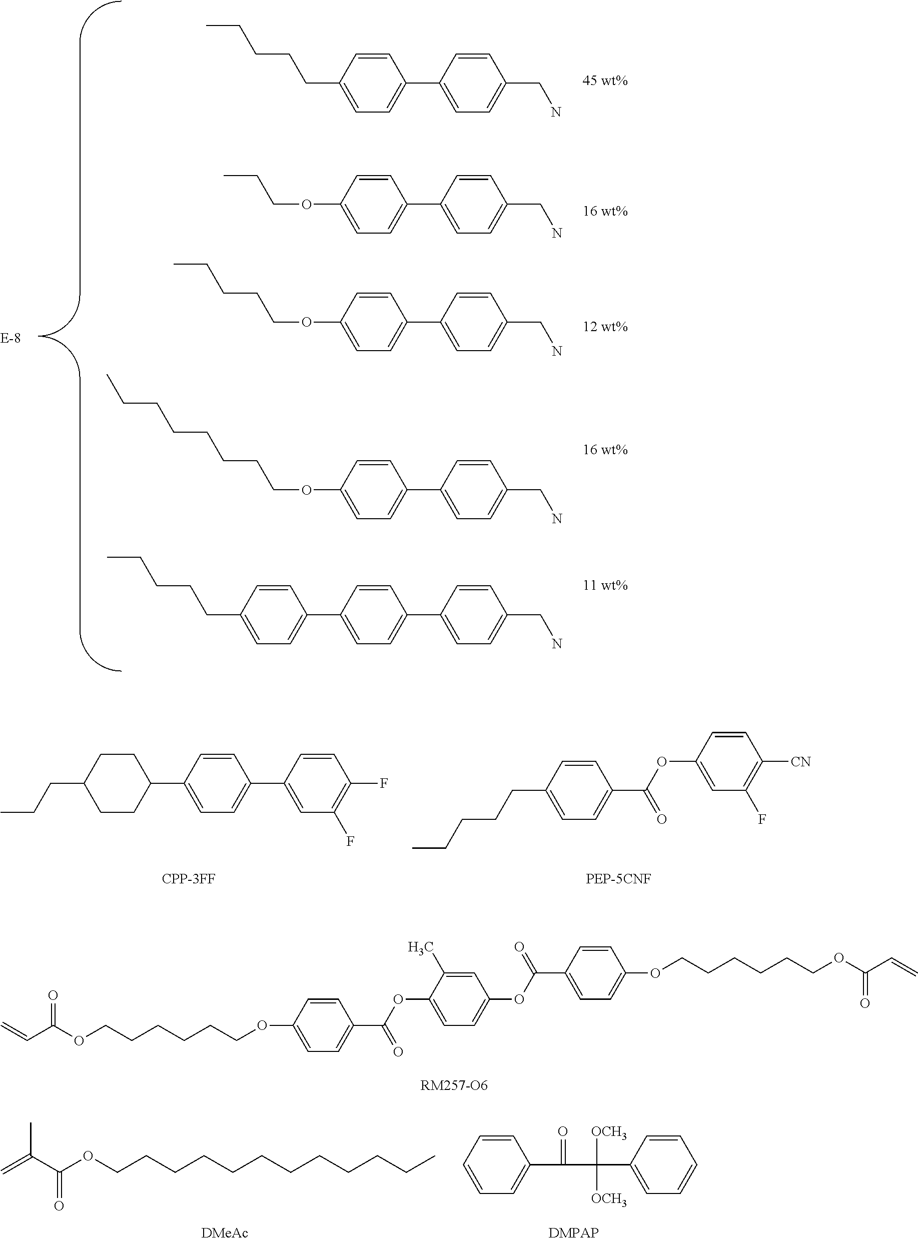

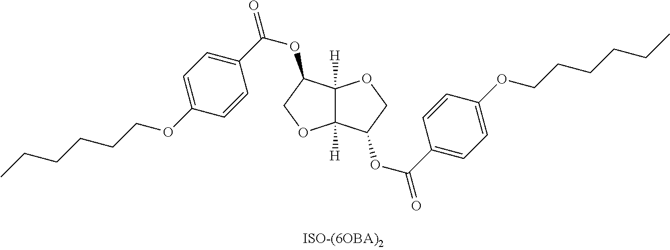 [SMILES: CCCCCCOc1ccc(C(=O)O[C@H]2CO[C@H]3[C@@H]2OC[C@H]3OC(=O)c2ccc(OCCCCCC)cc2)cc1]

Note that E-8 (abbreviation) in the liquid crystal material is a mixture of five kinds of substances (4-cyano-4′-pentylbiphenyl, 4-cyano-4′-propyloxybiphenyl, 4-cyano-4′-pentyloxybiphenyl, 4-cyano-4′-octyloxybiphenyl, and 4-cyano-4″-pentyl-p-terphenyl) in proportions (wt %) written besides the above structural formulae. The liquid-crystalline monomer RM257-O6 (abbreviation) is a liquid-crystalline monomer with an oxyalkylene group having a chain length n (including carbon atoms and oxygen atoms) of 7.

The proportions of the above-described substances in the liquid crystal composition used for the composite of a polymer and a liquid crystal formed under the conditions A are shown below.

TABLE 1

| | Material | Mix proportion |
|---|---|---|
| Category | name | (wt %) |
| Liquid crystal material | E-8 | 34.0 |
| | CPP-3FF | 25.5 |
| | PEP-5CNF | 25.5 |
| Liquid-crystalline monomer | RM257-O6 | 4.0 |
| Non-liquid-crystalline | DMeAc | 4.0 |
| monomer | | |
| Polymerization initiator | DMPAP | small amount |
| Chiral agent | ISO-(6OBA)₂ | 6.9 |
| Total | | 100.0 |

The liquid crystal material contained in the liquid crystal composition used for the composite of a polymer and a liquid crystal formed under the conditions A exhibited a blue phase at 30.5° C. to 36.4° C. In other words, the point of phase transition between a cholesteric phase and a blue phase in the liquid crystal material contained in the liquid crystal composition was 30.5° C., and the point of phase transition between an isotropic phase and a blue phase therein was 36.4° C.

### (Polymer Stabilization Treatment)

Under the conditions A, a liquid crystal cell was fabricated by using a sealant to enclose a liquid crystal composition provided between a pair of glass substrates. Then, the liquid crystal cell was subjected to polymer stabilization treatment. Note that the liquid crystal cell was fabricated by attaching the pair of glass substrates with the sealant with a gap (6 μm) therebetween and then injecting the liquid crystal composition into a space between the pair of glass substrates by an injection method. As the sealant, an ultraviolet and heat curable sealant was used. Furthermore, the sealant was subjected to ultraviolet light (irradiance: 100 mW/cm²) irradiation treatment for 90 seconds as curing treatment. Then, the liquid crystal cell was subjected to heat treatment at 120° C. for 1 hour. Then, polishing treatment was performed such that the thickness of one of the pair of glass substrates on the side to be observed with a confocal laser microscope became 0.17 mm. Note that the thickness of each of the pair of glass substrates before the treatment was 0.7 mm.

The polymer stabilization treatment was performed by raising the temperature to 70° C. where the liquid crystal material contained in the liquid crystal composition exhibits an isotropic phase and then lowering the temperature to 36° C., and by irradiating the liquid crystal cell held in that state with ultraviolet light (wavelength: 365 nm, irradiance: 8 mW/cm²) for 6 minutes.

### (Composite of Polymer and Liquid Crystal)

By the above-described polymer stabilization treatment, the composite of a polymer and a liquid crystal formed under the conditions A was obtained.

<Observation 1 on Composite of Polymer and Liquid Crystal Formed under Conditions A with Confocal Laser Microscope>

FIG. 8 and FIG. 9 show textures of the composite of a polymer and a liquid crystal formed under the conditions A, which were observed with a confocal laser microscope. Note that an optical system of a confocal laser microscope is characterized by the capability of eliminating information of the non-focal plane and extracting only information of the focal plane. In other words, when the focal plane is set as appropriate in the observation with the confocal laser microscope, a desired plane perpendicular to the thickness direction of an object can be observed. By utilization of this feature of the confocal laser microscope, observation images (textures) shown in FIGS. 8 and 9 were obtained. Specifically, FIG. 8 shows an observation image of the composite of a polymer and a liquid crystal in a region (a surface region) in the vicinity of the glass substrate on the observation side, and FIG. 9 shows an observation image of the composite of a polymer and a liquid crystal in a bulk region (an inner region). Note that the observations were performed using a laser with a wavelength of 488 nm under the following conditions: a measurement mode was a reflective mode; the magnification of an objective lens was 100 times; and the temperature was room temperature.

In the imaging data in FIG. 8 of the composite of a polymer and a liquid crystal formed under the conditions A taken with the confocal laser microscope, a stripe pattern owing to alignment of the composite of a polymer and a liquid crystal was observed. At least two regions where the stripe patterns in different alignments are adjacent to one another without a boundary (in the image data, some of the corresponding portions are shown by circles) exist per area of 15 μm×15 μm. In the composite of a polymer and a liquid crystal showing such an observation image, a boundary between different alignments is relatively not clear, which means that an amount of light leaks from the boundary can be reduced.

A texture (FIG. 8) in a region near a glass substrate (a surface region) differs from a texture (FIG. 9) in a bulk region (an inner region). Specifically, a portion (which corresponds to a defect such as a boundary between alignments) observed as a dark portion in the surface region in FIG. 8 disappears or additionally appears in FIG. 9. In the composite of a polymer and a liquid crystal which shows such textures, a portion where a boundary between alignments is not continuous exists in the thickness direction of a liquid crystal layer; thus, light leakage can be reduced further effectively.

In FIG. 8 and FIG. 9, a plurality of units (one unit also referred to as one domain) of the composite of a polymer and a liquid crystal which have different alignments and different stripe patterns are observed. A bonding part exists between one domain and at least one adjacent domain. This can be regarded as a phenomenon that different domains partly bond to each other. In the composite of a polymer and a liquid crystal showing such an observation image, a boundary is unclear, which means that light leakage can be further reduced.

As described above, it was found that the composite of a polymer and a liquid crystal according to one embodiment of the present invention has a favorable characteristic of less light leakage. A liquid crystal display device manufactured with the use of the composite of a polymer and a liquid crystal which causes less light leakage can display high-contrast images.

<Observation 2 on Composite of Polymer and Liquid Crystal Formed under Conditions A with Confocal Laser Microscope>

FIG. 10 shows a texture of the composite of a polymer and a liquid crystal formed under the conditions A, which was observed with a confocal laser microscope. Note that the observation was performed using a laser with a wavelength of 488 nm under the following conditions: a measurement mode was a reflective mode; the magnification of an objective lens was 100 times; and the temperature was room temperature.

FIG. 10 shows that periodicity of alignment of a plurality of domains is lowered in the composite of a polymer and a liquid crystal formed under the conditions A. Specifically, it was observed that adjacent domains among the plurality of domains have different periods of alignment, i.e., at least polar angles of the adjacent domains or azimuths of the adjacent domains are different; and a boundary between the adjacent domains includes a first contact 502 at which the periods of alignment of the adjacent domains are different and a second contact 504 at which the periods of alignment of the adjacent domains are bonded.

### <Conditions B>

### (Liquid Crystal Composition)

A liquid crystal composition used for the composite of a polymer and a liquid crystal formed under the conditions B, which was used for the comparative example, includes E-8, CPP-3FF, and PEP-5CNF as a liquid crystal material exhibiting a blue phase, 1,4-bis[4-(3-acryloyloxy-n-propyl-1-oxy)benzoyloxy]-2-methylbenzene (abbreviation: RM257-O3, produced by SYNTHON Chemicals GmbH & Co. KG) as a liquid-crystalline monomer, DMeAc as a non-liquid-crystalline monomer, DMPAP as a polymerization initiator, and ISO-(60BA)₂ as a chiral material. In short, the liquid crystal composition used for this comparative example includes the same substances as those used for the composite of a polymer and a liquid crystal formed under the conditions A, except the liquid-crystalline monomer.

The structural formula of the liquid-crystalline monomer RM257-O3 (abbreviation) is shown below.

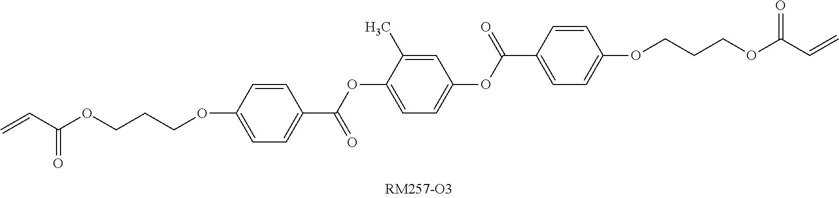 [SMILES: C=CC(=O)OCCCOc1ccc(C(=O)Oc2ccc(OC(=O)c3ccc(OCCCOC(=O)C=C)cc3)c(C)c2)cc1]

Note that the liquid-crystalline monomer RM257-O3 (abbreviation) is a liquid-crystalline monomer with an oxyalkylene group having a chain length n (including carbon atoms and oxygen atoms) of 4.

The proportions of the above-described substances in the liquid crystal composition used for the composite of a polymer and a liquid crystal formed under the conditions B, which is a comparative example, are shown below.

TABLE 2

| | Material | Mix proportion |
|---|---|---|
| Category | name | (wt %) |
| Liquid crystal material | E-8 | 34.0 |
| | CPP-3FF | 25.5 |
| | PEP-5CNF | 25.5 |
| Liquid-crystalline monomer | RM257-O3 | 4.0 |
| Non-liquid-crystalline | DMeAc | 4.0 |
| monomer | | |
| Polymerization initiator | DMPAP | small amount |
| Chiral agent | ISO-(6OBA)₂ | 6.9 |
| Total | | 100.0 |

The liquid crystal material contained in the liquid crystal composition used for the composite of a polymer and a liquid crystal formed under the conditions B, which is a comparative example, exhibited a blue phase at 30.7° C. to 38.4° C. In other words, the point of phase transition between a cholesteric phase and a blue phase in the liquid crystal material contained in the liquid crystal composition was 30.7° C., and the point of phase transition between an isotropic phase and a blue phase therein was 38.4° C.

### (Polymer Stabilization Treatment)

In this comparative example, a liquid crystal cell was fabricated by using a sealant to enclose the liquid crystal composition provided between a pair of glass substrates. Then, the liquid crystal cell was subjected to polymer stabilization treatment. Note that the liquid crystal cell was fabricated by attaching the pair of glass substrates with the sealant with a gap (6 μm) therebetween and then injecting the liquid crystal composition into a space between the pair of glass substrates by an injection method. As the sealant, an ultraviolet and heat curable sealant was used. Furthermore, the sealant was subjected to ultraviolet light (irradiance: 100 mW/cm²) irradiation treatment for 90 seconds as curing treatment. Next, the liquid crystal cell was subjected to heat treatment at 120° C. for 1 hour. Then, polishing treatment was performed such that the thickness of one of the pair of glass substrates on the side to be observed with a confocal laser microscope became 0.17 mm. Note that the thickness of each of the pair of glass substrates before the treatment was 0.7 mm

The polymer stabilization treatment was performed by raising the temperature to 70° C. where the liquid crystal material contained in the liquid crystal composition exhibits an isotropic phase and then lowering the temperature to 34° C., and by irradiating the liquid crystal cell held in that state with ultraviolet light (wavelength: 365 nm, irradiance: 8 mW/cm²) for 6 minutes.

### (Composite of Polymer and Liquid Crystal)

By the above-described polymer stabilization treatment, the composite of a polymer and a liquid crystal formed under the conditions B was obtained.

<Observation 1 on Composite of Polymer and Liquid Crystal Formed under Conditions B with Confocal Laser Microscope>

FIG. 11 and FIG. 12 show textures of the composite of a polymer and a liquid crystal formed under the conditions B, which were observed with a confocal laser microscope. Specifically, FIG. 11 shows an observation image of the composite of a polymer and a liquid crystal formed under the conditions B in a region in the vicinity of the glass substrate on the observation side, and FIG. 12 shows an observation image of the composite of a polymer and a liquid crystal formed under the conditions B in a bulk region (a center region between substrates). Note that the observations were performed using a laser with a wavelength of 488 nm under the following conditions: a measurement mode was a reflective mode; the magnification of an objective lens was 100 times; and the temperature was room temperature.

FIG. 11 shows that in the composite of a polymer and a liquid crystal formed under the conditions B, which is a comparative example, the directions of stripe patterns owing to alignment of the composite of a polymer and a liquid crystal on both sides of a boundary are different from each other. In other words, a boundary exists between a stripe pattern in one direction and a stripe pattern in another direction. A stripe pattern in one direction is adjacent to a stripe pattern in another direction without a boundary only occasionally. The number of such portions is one or less in an area of 15 μm×15 μm.

The boundary seen in FIG. 11 is also seen in FIG. 12; thus, it is found that in the composite of a polymer and a liquid crystal formed under the conditions B, a boundary (which is a defect) continuously exists in the thickness direction of a liquid crystal layer. Consequently, light likely to leak through a boundary. As described above, in the composite of a polymer and a liquid crystal formed under the conditions B, it was observed that periods of alignment of the plurality of domains have high order.

In such a composite of a polymer and a liquid crystal, a boundary that exists between stripe patterns with different directions (between different alignments) is clear, and light leaks through the boundary. For this reason, in the case where the composite of a polymer and a liquid crystal is used for a display, it is difficult to improve the contrast of the display.

### <Reflectance Spectrum Measurement>

Next, the reflectance spectra of the composite of a polymer and a liquid crystal formed under the conditions A and the composite of a polymer and a liquid crystal formed under the conditions B were measured. The reflectance spectrum measurements were performed with respect to incident light having a wavelength of 300 nm to 800 nm. Note that Samples 1 to 4 of the composite of a polymer and a liquid crystal formed under the conditions A and Samples 1 to 4 of the composite of a polymer and a liquid crystal formed under the conditions B were prepared. The reflectance spectrum and the half width of the reflectance spectrum of each sample were measured.

FIG. 13A shows the results of the reflectance spectrum measurements of the composites of a polymer and a liquid crystal formed under the conditions A, and FIG. 13B shows the results of the reflectance spectrum measurements of the composites of a polymer and a liquid crystal formed under the conditions B. Table 3 shows the half widths of the reflectance spectra of the composites of a polymer and a liquid crystal formed under the conditions A and the composites of a polymer and a liquid crystal formed under the conditions B.

TABLE 3

| | Half width of reflectance spectrum [nm] | | | | |
|---|---|---|---|---|---|
| | Sample | Sample | Sample | Sample | |
| | 1 | 2 | 3 | 4 | Remarks |
| Condition A | 31 | 34 | 36 | 36 | Present invention |
| Condition B | 28 | 26 | 27 | 29 | Comparative |
| | | | | | example |

It is shown that each of the composites of a polymer and a liquid crystal formed under the conditions A, which is one embodiment of the present invention, has a half width of the reflectance spectrum in a range of 31 nm to 36 nm. Although not described in this example, it was found that a half width of about 50 nm can be achieved depending on conditions. On the other hand, it is shown that each of the composite of a polymer and a liquid crystal formed under the conditions B, which is a comparative example, has a half width of the reflectance spectrum in a range of 26 nm to 29 nm.

As described above, the composite of a polymer and a liquid crystal formed under the conditions A, which is one embodiment of the present invention, has a structure in which periodicity of alignment of a plurality of domains is lowered, so that the reflectance spectrum is broad and the half width is long. On the other hand, the composite of a polymer and a liquid crystal formed under the conditions B, which is a comparative example, has a structure with high periodicity of alignment of a plurality of domains, so that the reflectance spectrum has a sharp peak and thus the half width is short.

This application is based on Japanese Patent Application serial no. 2012-055786 filed with Japan Patent Office on Mar. 13, 2012 and Japanese Patent Application serial no. 2012-055799 filed with Japan Patent Office on Mar. 13, 2012, the entire contents of which are hereby incorporated by reference.

What is claimed is:

1. A liquid crystal layer comprising a liquid crystal, the liquid crystal layer comprising:
a first domain in which the liquid crystal aligns in a first alignment state; and
a second domain in which the liquid crystal aligns in a second alignment state which is different from the first alignment state,
wherein the first domain and the second domain are adjacent to each other, and
wherein a boundary between the first domain and the second domain comprises a region in which an alignment state continuously changes between the first alignment state and the second alignment state.

2. The liquid crystal layer according to claim 1, wherein the liquid crystal exhibits a blue phase.

3. The liquid crystal layer according to claim 1, wherein the first domain and the second domain are partly bonded to each other.

4. The liquid crystal layer according to claim 1, wherein a half width of a reflectance spectrum is greater than or equal to 30 nm and less than or equal to 60 nm when the liquid crystal layer is irradiated with light having a wavelength of 300 nm to 800 nm.

5. The liquid crystal layer according to claim 1, wherein the liquid crystal is stabilized with a polymer.

6. A liquid crystal layer comprising a liquid crystal, the liquid crystal layer comprising:
a first region comprising a first stripe pattern along a first direction; and
a second region comprising a second stripe pattern along a second direction which is different from the first direction,
wherein the first region and the second region are adjacent to each other, and
wherein a boundary between the first region and the second region comprises a third region in which the first stripe pattern and the second stripe pattern disappear.

7. The liquid crystal layer according to claim 6, wherein the liquid crystal exhibits a blue phase.

8. The liquid crystal layer according to claim 6, wherein the first region and the second region are partly bonded to each other.

9. The liquid crystal layer according to claim 6, wherein a half width of a reflectance spectrum is greater than or equal to 30 nm and less than or equal to 60 nm when the liquid crystal layer is irradiated with light having a wavelength of 300 nm to 800 nm.

10. The liquid crystal layer according to claim 6, wherein the liquid crystal is stabilized with a polymer.

11. A display device comprising:
a pixel electrode; and
a liquid crystal layer comprising a liquid crystal over the pixel electrode,
wherein the liquid crystal layer comprises:
a first domain in which the liquid crystal aligns in a first alignment state; and
a second domain in which the liquid crystal aligns in a second alignment state which is different from the first alignment state,
wherein the first domain and the second domain are adjacent to each other, and
wherein a boundary between the first domain and the second domain comprises a region in which an alignment state continuously changes between the first alignment state and the second alignment state.

12. The display device according to claim 11, wherein the liquid crystal exhibits a blue phase.

13. The display device according to claim 11, wherein the first domain and the second domain are partly bonded to each other.

14. The display device according to claim 11, wherein a half width of a reflectance spectrum is greater than or equal to 30 nm and less than or equal to 60 nm when the liquid crystal layer is irradiated with light having a wavelength of 300 nm to 800 nm.

15. The display device according to claim 11, wherein the liquid crystal is stabilized with a polymer.

16. The display device according to claim 11, further comprising a common electrode over the liquid crystal layer.

17. The display device according to claim 11, further comprising a common electrode, wherein the liquid crystal layer is over the common electrode.

18. The display device according to claim 17, further comprising an insulating layer, wherein the pixel electrode and the common electrode are on and in contact with the insulating layer.

19. The display device according to claim 11, further comprising a pair of glass substrates between which the pixel electrode and the liquid crystal layer are provided.
